(19) United States
(12) Patent Application Publication
(10) Pub. No.: US 2024/0359162 A9
(43) Pub. Date: Oct. 31, 2024

(54) METHOD OF FORMING INTEGRATED COMPOSITE COMPRISING CONDUCTIVE CARBON NETWORK

(71) Applicant: Sustaera Inc., Durham, NC (US)

(72) Inventors: Tyson Lee LANIGAN-ATKINS, Durham, NC (US); Jian-Peng SHEN, Chapel Hill, NC (US); Cory Elliott SANDERSON, Wendell, NC (US); Raghubir Prasad GUPTA, Durham, NC (US)

(21) Appl. No.: 18/502,262

(22) Filed: Nov. 6, 2023

Related U.S. Application Data
(63) Continuation-in-part of application No. 18/280,509, filed on Sep. 6, 2023.
(60) Provisional application No. 63/158,807, filed on Mar. 9, 2021.

(51) Int. Cl. B01J 20/32; B01D 53/62; B01D 53/82; B01D 53/96; B01J 20/04; B01J 20/08; B01J 20/28; B01J 20/30; B01J 20/34; B05D 3/02

(52) U.S. Cl. CPC B01J 20/3204; B01D 53/62; B01D 53/82; B01D 53/96; B01J 20/043; B01J 20/08; B01J 20/28042; B01J 20/3078; B01J 20/3234; B01J 20/3291; B01J 20/3433; B01J 20/3458; B01J 20/3483; B05D 3/0254; B01D 2251/304; B01D 2251/606; B01D 2257/504; B01D 2258/06

(57) ABSTRACT

A method for forming an integrated composite comprises providing a three-dimensional substrate having at least one channel; coating the substrate with a phenolic resin, wherein coating comprises dispersing the phenolic resin on the substrate, impregnating the phenolic resin in the substrate or a combination of both; curing the substrate and the phenolic resin; heating the cured substrate and cured phenolic resin to a temperature in a range of about 600° C. to about 1100° C. in an inert environment thereby pyrolyzing the phenolic resin, forming a conductive carbon network on, in, or both on and in the substrate; and coating a support material on, in, or both on and in the substrate to form an integrated composite.

### CROSS-REFERENCE TO RELATED APPLICATIONS

This application is a continuation-in-part application of U.S. application Ser. No. 18/280,509, filed Sep. 6, 2023, which was a national stage application of International Application No. PCT/US22/19564, filed Mar. 9, 2022, which claimed the benefit of U.S. Provisional Patent Application No. 63/158,807, filed Mar. 9, 2021, the entire contents of all of which are incorporated by reference herein.

### STATEMENT OF FEDERALLY FUNDED RESEARCH

This invention was made with United States Government support under contract numbers DE-SC0020795 and DE-FE0032118 awarded by the U.S. Department of Energy. The United States Government has certain rights in the invention.

### FIELD

The present disclosure generally relates to capture and removal of carbon dioxide from air and point source streams, and in various aspects relates to materials, assemblies, methods, and apparatus for direct air capture of carbon dioxide.

### DESCRIPTION OF THE RELATED ART

Carbon dioxide is a major greenhouse gas in the Earth's atmosphere that has consistently increased in the atmosphere in the Anthropocene era, from preindustrial concentrations on the order of 280 ppm by volume to the current atmospheric concentrations exceeding 415 ppm by volume. The generative causes and pernicious effects of such increasing levels of atmospheric carbon dioxide are well recognized, as including mediation of climatological increases in temperature, as well as progressive acidification of the planet's surface and subsurface waters, with consequent adverse effects on marine and freshwater lifeforms and habitat. Since carbon dioxide has a long atmospheric lifetime of hundreds to thousands of years, ambient carbon dioxide has become a focus of substantial concern and has intensified efforts to restrict CO₂ concentrations from increasing, by implementation of CO₂ abatement and sequestration technologies, and reduction, elimination, and replacement of existing sources of CO₂ emissions.

In consequence, the art continues to seek improvements in CO₂ capture, removal, and containment technologies to combat increasing ambient levels of carbon dioxide and associated adverse effects to which all plants, animals, and habitats on Earth are ultimately and unavoidably exposed. CO₂ capture has been used to reduce CO₂ emissions from large stationary sources, such as fossil-fuel-based power stations, crude oil refineries, cement facilities, and iron or steel industry installations. Improvements in efficiency and effectiveness of CO₂ capture are needed. The direct extraction of CO₂ from ambient air is referred to herein as carbon dioxide removal (CDR) or direct air capture (DAC). Improvements in the efficiency and effectiveness of DAC are needed.

### SUMMARY

In a first aspect of the invention, a method for forming an integrated composite comprises providing a three-dimensional substrate having at least one channel, coating the substrate with a phenolic resin, wherein coating comprises dispersing the phenolic resin on the substrate, impregnating the phenolic resin in the substrate or a combination of both; curing the substrate and the phenolic resin; heating the cured substrate and cured phenolic resin to a temperature in a range of about 600° C. to about 1100° C. in an inert environment thereby pyrolyzing the phenolic resin, forming a conductive carbon network on, in, or both on and in the substrate; and coating a support material on, in, or both on and in the substrate to form an integrated composite.

In a feature of this aspect, the method further comprises coating a sorbent on or in the integrated composite. The sorbent can comprise one or more CO₂ sorbents. The sorbent can comprise a solid inorganic base. The sorbent can comprise one or more of amino acid, amino acid salt, sodium oxide, sodium carbonate, calcium oxide, calcium carbonate, potassium carbonate, magnesium oxide, magnesium hydroxide, magnesium carbonate, barium oxide, or barium carbonate. The amino acid salt may comprise one or more of sodium lysinate, potassium lysinate, lithium lysinate, potassium glycinate, sodium glycinate, lithium glycinate, histidine sodium salt, taurine sodium salt, aspartic acid sodium salt, asparagine sodium salt, alanine sodium salt, leucine sodium salt, or taurine potassium salt (potassium taurate).

In another feature of this aspect, curing comprises heating the substrate coated with phenolic resin to a temperature of about 100° C. to 150° C. to cure it prior to pyrolyzing it. In an additional feature, the three-dimensional substrate can comprise a monolithic, laminate, or wire mesh form. The substrate can comprise cordierite, alumina, silica/alumina, silicon carbide (SiC), titania, silica, magnesia, zirconia, metal mesh, carbon, and combinations thereof.

In a second aspect of the invention, a structured material assembly for removing CO₂ from a gas comprises a three-dimensional substrate, a conductive carbon network coated on the three-dimensional substrate, and a sorbent for adsorbing CO₂ from the gas. In a feature of this aspect, the conductive carbon network is responsive to inputted energy to generate heat to desorb CO₂ from the sorbent.

Other aspects, features and embodiments of the disclosure will be more fully apparent from the ensuing description and appended claims.

### BRIEF DESCRIPTION OF THE DRAWINGS

FIG. 1 is a schematic view of the frontal cross-section of the monolith substrate.

FIG. 2 is perspective view of the monolith substrate shown in FIG. 1.

FIG. 3 is the resulting cross-section of a single monolith channel coated with sorbent material, sorbent support material, and desorption material.

FIG. 4 is an exploded view of the monolith substrate, the highly conductive coating layer, and the wire mesh/electrode connections for power delivery.

FIG. 5 is an unexploded view of the monolith substrate, the highly conductive coating layer, and the wire mesh/electrodes assembled to form a structured material assembly (SMA).

FIG. 6 is a schematic showing the arrangement of a multitude of structured material assemblies (SMAs) into the internal components of a module as well as the primary electrical connection busbars.

FIG. 7 is a drawing showing a completed module including the multitude of SMAs and the module housing.

FIG. 8 is a perspective view of an ambient air intake unit of a direct air capture apparatus according to one embodiment of the disclosure.

FIG. 9 is a top plan view of the ambient air intake unit shown in FIG. 8.

FIG. 10 is a front elevation view of the air intake unit shown in FIG. 8.

FIG. 11 shows the outlet CO₂ concentration as a cordierite monolith that is coated with alumina, a conductive carbon paint, and Na₂CO₃ is resistively heated.

FIG. 12 shows the cumulative CO₂ desorbed as a cordierite monolith that is coated with alumina, a conductive carbon paint, and Na₂CO₃ is resistively heated.

FIG. 13 shows the outlet CO₂ concentration as a cordierite monolith that is coated with alumina, a conductive carbon paint, and Na₂CO₃ is resistively heated.

FIG. 14 shows the cumulative CO₂ desorbed as a cordierite monolith that is coated with alumina, a conductive carbon paint, and Na₂CO₃ is resistively heated.

FIG. 15 shows monolith temperature as it is resistively heated.

FIG. 16 is a breakthrough curve for a carbon-cordierite composite monolith that is coated with a sorbent.

FIG. 17 shows the cumulative CO₂ adsorbed by a carbon-cordierite composite monolith that is coated with a sorbent.

FIG. 18 shows the cumulative CO₂ adsorbed/desorbed for a carbon-cordierite composite monolith that is coated with a sorbent.

FIG. 19 shows the outlet CO₂ concentration as a carbon-cordierite composite monolith that is coated with a sorbent is resistively heated.

FIG. 20 shows the cumulative CO₂ desorbed as carbon-cordierite composite monolith that is coated with a sorbent is resistively heated.

FIG. 21 shows the outlet CO₂ concentration as a carbon-cordierite composite monolith that is coated with a sorbent is resistively heated.

FIG. 22 shows the cumulative CO₂ desorbed as a carbon-cordierite composite monolith that is coated with a sorbent Na₂CO₃ is resistively heated.

FIG. 23 shows the monolith temperature as a function of time as a carbon-cordierite composite monolith coated with a sorbent is resistively heated.

FIG. 24 shows a simplified process flow diagram demonstrating the inlet flow of air and outlet flows of CO₂-lean air and removed CO₂ streams and some downstream processes.

FIG. 25 shows a detailed process flow diagram demonstrating the inlet flow of air, energy sources for desorption, outlet flows of CO₂-lean air and removed CO₂ streams, and downstream processes.

FIG. 26 shows the temperature of a large (5.9 inch×5.9 inch×3.9 inch) cordierite monolith coated with a conductive carbon layer as it is resistively heated.

FIG. 27 schematically shows the resistance across a large (5.9 inch×5.9 inch×3.9 inch) cordierite monolith, coated with a conductive carbon layer, before and after adding silver paint as flow-through electrodes.

FIG. 28 is an image of the pyrolyzed monolith of Example 5 prepared for heat testing.

FIG. 29 is a chart showing temperature as a function of distance in meters along the fiber optic temperature probe for probes 1-16 in Example 5.

FIG. 30 is a graph showing the power input to the monolith over five heating cycles.

FIG. 31 is a graph showing monolith resistance over time for the five heating cycles.

FIG. 32 is a schematic flow chart showing the processing steps for the first core and the second core in Example 6.

FIG. 33 is a chart showing adsorption capacity per cycle in Example 7.

FIG. 34 is a chart showing temperature at a single exemplary point in time in Example 7.

### DETAILED DESCRIPTION

The present disclosure relates generally to capture or removal of CO₂ from any source or stream, including point source or industrial emissions and removal of CO₂ from ambient air. In embodiments, a structured material assembly includes components for CO₂ removal or capture employing a relatively low pressure drop substrate with a suitable CO₂ capture agent or sorbent and integrated heating.

Integrated heating may be via electricity, which can provide advantages in efficiency and reduced energy losses and can allow use of renewable energy sources. For example, integrated electrical heating is quick, which desorbs CO₂ relatively fast thereby reducing energy losses to the environment, the atmosphere, and the structure itself. Using electricity for integrated heating enables the use of renewable electricity sources such as solar energy and wind energy, which have lower carbon intensity and emissions than fossil fuels. Moreover, the overall energy efficiency is higher relative to steam heating. The disclosure includes descriptions related to materials, assemblies, methods, and apparatus for capture and removal of carbon dioxide.

As used herein and in the appended claims, the singular forms “a”, “an”, and “the” include plural referents unless the context clearly dictates otherwise.

As used herein, the terms “about” and “approximately” shall generally mean an acceptable degree of error for the quantity measured given the nature or precision of the measurements. Exemplary degrees of error are within 20-25 percent (%), typically, within 10%, and more typically, within 5% of a given value or range of values. The terms “about” and “approximately” include the recited value being modified; for example, “about 1.5” includes the recited value 1.5, as well as an acceptable degree of error around the recited value 1.5.

In the ensuing description, unless otherwise expressly stated, percentages pertaining to gas and fluid compositions are percentages by volume of the total gas or fluid volume, and percentages pertaining to solid compositions are percentages by weight of the total solid composition weight.

The disclosure, as variously set out herein in respect of features, aspects, and embodiments thereof, may, in particular implementations, be constituted as comprising, consisting, or consisting essentially of, some or all of such features, aspects and embodiments, as well as elements and components thereof being aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the invention. The disclosure may therefore be specified as comprising, consisting or consisting essentially of any of such combinations and permutations of these specific features, aspects and embodiments, or a selected one or ones thereof.

In one aspect, a structured material assembly (SMA), comprises: a substrate material, a carbon dioxide (CO₂) sorbent, and a desorption material that is responsive to inputted energy to generate heat in-situ to desorb CO₂ from the sorbent in the structured material assembly. The substrate material may be referred to herein as “substrate.” Thus, the terms “substrate material” and “substrate” may be used interchangeably. In embodiments, the substrate material, the sorbent, and the desorption material are arranged such that the substrate material is in a supporting relationship with the sorbent and the desorption material. For example, the sorbent may be deposited on or in the substrate, and the desorption material may be deposited on or in the substrate. The structured material assembly may be used to capture or remove CO₂ from any source or stream, such as a point source emission (stationary or mobile) or directly from ambient air.

The substrate material can be present in various forms or structures, depending on suitability for a particular application. The substrate can provide a reinforcing or supportive structure for the sorbent and/or desorption material. For example, the substrate material may be in monolithic form, laminate form, or wire mesh form. The material of construction of the substrate may be of any suitable type, and may, for example, comprise a ceramic, metal, organic, and/or inorganic material.

The substrate material may comprise cordierite, alumina, silica/alumina, silicon carbide (SiC), titania, silica, magnesia, zirconia, metal mesh, carbon, and combinations thereof. The substrate may for example comprise a ceramic such as cordierite, titania, alumina, mullite, carbon/ceramic composite, SiC, or SiC/ceramic composite in a monolithic form. It is generally understood that cordierite comprises a mixture of components, including MgO, Al₂O₃ and SiO₂. Conventionally, the composition of cordierite is represented as 2MgO·2Al₂O₃·5SiO₂. This cordierite composition 2MgO·₂Al₂O₃·5SiO₂ may be suitably tailored to have different molar ratios and starting raw material properties of magnesia, alumina, and silica to meet the performance targets for the substrate. Additionally, components, such as talc, clay, kaolin, and raw alumina powder may also be used for cordierite preparation.

A monolithic structure is self-supporting. It has multiple, parallel channels or holes defined by many walls (typically, thin walls), which can be in a honeycomb-like structure. The channels can have various shapes, including, for example, square, hexagonal, round, or other geometries. The channels provide a relatively large surface area, which can aid in the sorption of CO₂. The open channels in a front face or surface of the monolith can occupy a relatively large amount of the front cross-sectional area such that resistance of flow of gas through the channels is relatively low, thus minimizing the pressure drop which is the energy needed to force the gas through the monolith.

The substrate material in monolith form may have walls with varying porosity, surface area, and pore size depending on the material and production method employed to create the monolith form. These properties are important to obtain desired adsorption rate of CO₂, CO₂ capture capacity, CO₂ desorption rate, and cyclic performance.

The substrate material may be present in a form that is effective to constitute the structured material assembly as a laminated structure, e.g., wherein the substrate material is present in the form of multiple individual sheets of the substrate stacked on each other with a spacer material to provide a gap between the sheets to form channels for gas or fluid to flow. The spacer material can be electrically insulating to prevent electrical current from short circuiting from one laminate layer to another. The individual sheets may take the form of woven and/or non-woven sheets and may be an organic material such as carbon paper, carbon cloth, carbon fiber, or carbon nanostructures, or a metal material such as steel, aluminum, copper, iron, or alloys thereof.

In still other embodiments, the structured material assembly is constituted, as comprising a laminate comprising sheets of the regeneration material coated with the CO₂ sorbent, wherein the regeneration material comprises carbon, wherein adjacent sheets of the laminate are in contact with each other through an insulating material to prevent short circuiting, and wherein sheets of the laminate have electrical connections at respective spaced-apart portions thereof, with electrical connections at corresponding ones of the respective spaced-apart portions of the sheets being electrically coupled to form a positive electrode of the laminate, and with electrical connections at corresponding others of the respective spaced-apart portions of the sheets being electrically coupled to form a negative electrode of the laminate, wherein when the positive electrode and the negative electrode are coupled with an electrical energy source in circuit-forming relationship, electrical current flows between the electrodes through the sheets in the laminate.

The substrate material may be present in a form that is effective to constitute the structured material assembly through 3D printing via methods such as stereolithography, fused deposition modeling, direct metal laser sintering, or electron beam melting. Materials for 3D printing vary based on the additive manufacturing method and can include various ceramics, metals, polymers, and combinations thereof and a wide range of electrical and thermal conductivities as well as porosity, surface area, and mechanical strength properties which can be further modified during and after the additive manufacturing process.

The structured material assembly further comprises a desorption material, which may be of any suitable type of material that is responsive to inputted energy to generate heat in-situ to desorb CO₂ from the sorbent in the structured material assembly. The desorption material may have any suitable physicochemical properties to achieve the desired regeneration or desorption of CO₂. The desorption material is generally electrically conductive and can create a percolation network within the structured material assembly (SMA) when combined with the substrate material during forming to achieve an overall electrical resistivity target in a range of from 0.03 to 300 Ω-m. A suitable temperature range for desorption of CO₂ is from 40° C. to 200° C. As used herein, the term “electrical resistivity” means resistance of the SMA as measured from an inlet to an outlet of the SMA along a length of the flow channels, multiplied by an area of the solid SMA (excluding the open channel area), and divided by the length of SMA from inlet to outlet channels.

The desorption material may also be referred to herein as regeneration material. The desorption material may comprise multiple components, all of which may be referred to herein as regeneration material or materials, such as resistive components and conductive components. Exemplary desorption materials may include, for example, carbon, silicon carbide, barium titanate, strontium titanate, titanium carbon aluminum alloy, iron aluminum alloy, nickel chrome aluminum alloy, and iron nickel alloy. In embodiments in which the desorption material comprises carbon, such desorption material may for example include at least one of graphite, carbon black, hard carbon, amorphous carbon, and carbon nanotubes.

In embodiments, the desorption material may be a conductive carbon network. The conductive carbon network can be formed on a substrate through a series of steps.

For example, a method for forming a conductive carbon network on a substrate comprises providing a three-dimensional substrate, coating the substrate with a phenolic resin, curing the substrate and the phenolic resin coated on the substrate, and heating the cured substrate and cured resin to a temperature between 600-1100° C. to pyrolyze the cured phenolic resin, thus forming a conductive carbon network that can act as a desorption material on, in, or both on and in the substrate. It will be understood by those having ordinary skill in the art that the phenolic resin may be in solution form or slurry form. Thus, coating the substrate with a phenolic resin encompasses coating the substrate with a phenolic resin in solution form, slurry form, or any other suitable form known to a person having ordinary skill in the art.

In embodiments, to maintain suitable electrical conductivity for converting electrical energy into heat for desorption, the conductive carbon network is not activated in further processing. While it is known that activation of carbon has been performed in the art to create surface area for adsorption, activation of carbon reduces or eliminates its electrical conductivity. Activating the carbon network formed on the substrate would reduce or eliminate its electrical conductivity, which would reduce its ability to serve as an effective desorption material. Thus, activation of the carbon network is not performed.

As used herein, the term “coating” the substrate encompasses one or more of dispersing the phenolic resin solution on or in the substrate and impregnating the phenolic resin solution on or in the substrate or a combination thereof. The term “coating” may mean that the phenolic resin is only on the exterior of the three-dimensional surface. However, “coating” may also mean that the phenolic resin is dispersed on the exterior surface and integrated into the interior of the substrate using any method that enables it.

In the described method, the substrate can be coated with a phenolic resin solution. The phenolic resin solution may comprise phenolic resin dissolved in water. Additionally, the phenolic resin solution can be diluted with water, preferably deionized water, in varying ratios. After the phenolic resin solution is coated on the substrate, the coated substrate is cured, and then the cured substrate and cured resin are pyrolyzed to decompose the cured phenolic resin thereby forming a conductive carbon network on or in the substrate or both on and in the substrate. The pyrolyzed phenolic resin forms a macroscopically continuous conductive carbon network into which electrical energy can be input to produce local heating through the substrate. The phenolic resin acts as a precursor to the conductive carbon network, thus, the phenolic resin may also be referred to herein as a desorption material precursor.

As described above, in embodiments, the substrate material may comprise a ceramic such as cordierite, titania, alumina, mullite, carbon/ceramic composite, SiC, or SiC/ceramic composite. The substrate may be in a monolithic form.

Starting from a ceramic substrate and coating it with a phenolic resin, which is then formed into a conductive carbon network, provides advantages over conventional green bodies formed of a conductive carbon material and sorbent material, which do not include a substrate. Advantageously, a ceramic substrate provides strength/stability, low water adsorption, temperature stability, and coat-ability during manufacturing and throughout the useful life of final application products. These advantages are not found in conventional green bodies formed of a conductive carbon material and sorbent material. Higher strength substrates, such as those described herein, can withstand the relatively harsh conditions in forming final application products, such as frequent machinery handling, and can last for several decades during use and operation in the final application products (e.g., CO₂ capture devices).

Moreover, substrate temperature stability at higher temperatures is beneficial because it ensures the substrate does not lose its useful performance properties during high-temperature pyrolysis. Pyrolysis temperatures used to form a conductive carbon network having a suitable conductivity range are high. Moreover, properties of the conductive carbon network are sensitive to pyrolysis temperature. For example, pyrolysis temperature impacts the thermal, oxidative, and water vapor stability of the conductive carbon network, which are important performance features for repeatability of heating the conductive carbon network over thousands of cycles in an end use application, for example, a commercial operation.

The pore size of the microporous material (sorbent, support, and/or substrate) is also an important feature of a CO₂ capture device because it impacts water vapor adsorption. For capture of CO₂ from the air or a point source water vapor is present, which competes with CO₂ for adsorption. A device that has a relatively smaller pore size will adsorb more water vapor than a device that has a relatively large pore size. Microporous materials are classified into three ranges, as defined by IUPAC, with the smallest being nanoporous materials with a pore size range of 0.2 to 2 nm, then mesoporous materials with 2 to 50 nm pore size, and finally macroporous materials with 50 to 1000 nm pore sizes being the largest. Specifically, water vapor adsorption is preferred with smaller diameter pores, such as nanoporous IUPAC classification or smaller pores (molecular sized). Moreover, it takes more energy to adsorb and desorb water than it does CO₂, thus, adsorbing more water leads to higher energy use, as well. As is shown in the art, activation of carbon substrates creates molecular and nanoporous size pores which adsorb water vapor more strongly.

In embodiments, the structured material assembly described herein comprises a substrate with relatively larger pore size (IUPAC mesoporous materials), which leads to less water adsorption, which also leads to lower energy use and higher CO₂ capture efficiency. Some conventional CO₂ capture devices are formed with activated carbon to increase carbon surface area or with a green body, which includes carbon integrated with a sorbent for high surface area. Both conventional devices have smaller micropores than the structured material assembly described herein, meaning both are less energy efficient and have decreased CO₂ capture efficiency relative to the SMA described herein. Additionally, for the integrated composite, after the conductive carbon network is formed on the substrate, the coat-ability of the carbon network and the substrate is maintained, which means a high-surface area support with mesoporous range pore size can be added as a coating if desired and can achieve adequate adhesion for commercial applications. Mesoporous supports are generally preferable for good CO₂ capture capacity and kinetics whilst minimizing water adsorption. The benefit of creating an integrated composite in this method is any sorbent for CO₂ capture can be added to the integrated composite which has (1) relatively low water pick up (2) high surface area of dispersion of sorbent and (3) an electrically conductive network for desorption of captured gases.

Phenolic resins are a large family of relatively low-cost polymers composed of a wide variety of structures. Most phenolic resin is derived from phenol and formaldehyde. In synthesis, the proportion of phenol and formaldehyde can vary, and, if used, the catalyst used for the reaction can vary (e.g., acidic or alkaline catalyst), thus the characteristics of the generated phenolic resins are diverse. Exemplary catalysts include acids, metals, and metal oxides. For example, sodium, ZnCl₂, citric acid, and/or para-toluene-sulphonic acid (PTSA) can be used as catalysts.

Phenolic resin can be cured by heating to form a thermoset polymer. In embodiments, the curing temperature may range from about 100° C. to about 150° C. Curing is a chemical process in polymer chemistry resulting in toughening or hardening of a polymer by cross-linking of polymer chains. Curing can be induced by heat, radiation, electron beams, or chemical additives. When heat is used to induce curing, processing variables, such as, for example, curing temperature, curing duration, ramp-up heating rate for both temperature and time, cooldown heating rate for both temperature and time, and curing environment or atmosphere (e.g., circulating or stagnant and air or inert gas) are taken into consideration. Catalysts can aid in crosslinking the resin upon curing. For example, a catalyst may be used to aid in crosslinking at relatively low temperatures (e.g., 90° C. to 150° C.).

Phenolic resins that have been cured and then heated to relatively high temperatures (for example, 450° C. to 1000° C.) thermally decompose to form carbonized materials. This thermal decomposition of a material at elevated temperatures, often in an inert environment, is referred to as pyrolysis. Pyrolysis involves a change in chemical composition. For phenolic resin, pyrolysis brings about carbonization. Controlling pyrolysis processing variables, such as, for example, heat treatment temperature, heating rate, soaking time, cooling rate, and atmosphere, can affect the resulting carbonized material.

In the methods described herein, pyrolysis temperatures vary but they will typically range from about 600° C. to about 1100° C. In embodiments, pyrolysis temperatures may range from about 800° C. to about 1100° C. or about 850° C. to about 1000° C. Heating rates may also vary, but they will typically range from about 1° C./min to about 5° C./min. Similarly, cooling rates may vary, but they will typically range from about 1° C./min to about 5° C./min. Additionally, pyrolysis takes place in an inert environment, which may be provided by introduction of nitrogen, argon, helium, or other inert gases. More particularly, the environment for pyrolysis needs to have a concentration of oxygen below 1000 ppm oxygen. For example, the oxygen content is below 100 ppm oxygen. An inert environment can also be provided by creating a vacuum or by combining introduction of inert gases with creating a vacuum. Pyrolysis duration can vary depending on the level of carbonization desired. In embodiments, pyrolysis duration may last from about 1 hour to about 6 hours at the maximum temperature.

Pyrolysis of phenolic resin forms the conductive carbonized network on the substrate. The conductive network is responsive to inputted energy to generate heat in-situ. The conductive network is generally electrically conductive and can create a percolation network when combined with the substrate material to achieve an overall electrical resistivity target in a range of from 0.03 to 300 Ω-m. As used herein, the term “electrical resistivity” means resistance of the coated substrate as measured from an inlet to an outlet along a length of the flow channels, multiplied by an area of the solid coated substrate (excluding the open channel area), and divided by the length of the substrate from inlet to outlet channels.

The desorption or regeneration material may be responsive to inputted electrical energy to produce electrical resistance heating as the in-situ heat, to effect desorption of CO₂. In this regard, the regeneration material may comprise one or more regeneration material components working collectively to enable desorption of the adsorbed CO₂. The regeneration material components may be chosen, functionalized, tuned or designed to be effective for the sorption material with which they are paired for the assembly. Thus, regeneration material components may be used alone or in combination with other regeneration material components suitable for pairing with the adsorption material of the assembly.

In embodiments with monolith forms, the regeneration material may be present in an amount of 2 to 50%, based on total weight of the structured material assembly.

Alternatively, the regeneration material may be responsive to other forms of energy to produce the in-situ heat for desorption of CO₂. For example, the regeneration material may be responsive to inputted microwave energy to produce the in-situ heat via dielectric heating, and the structured material assembly may correspondingly include a microwave generator, constructed, and arranged to impinge energy on the regeneration material for the in-situ heat generation. A useful regeneration material for such purpose, in various embodiments, may be silicon carbide, operating at suitable frequencies to affect the sorbent regeneration.

Additionally, or alternatively, the regeneration material may be responsive to other forms of energy to produce the in-situ heat for desorption of sorbed CO₂. For example, the regeneration material may be responsive to inputted radio frequency (RF) energy to produce the in-situ heat via dielectric heating to desorb CO₂ from the SMA, and the structured material assembly may correspondingly include a RF generator arranged to impinge energy on the regeneration material for the in-situ heat generation. A useful regeneration material for such a purpose, in various embodiments, comprises carbon.

In embodiments, a support component may be deposited on or dispersed on or in the substrate. Exemplary support components include, without limitation, alumina, titania, silica, zirconia, and combinations thereof. Support components may be useful in embodiments where the substrate material has relatively low BET surface area. In these embodiments, the support component can have a higher surface area than that of the substrate material. For example, a cordierite monolith generally has a low surface area. Thus, for an SMA having a cordierite substrate, it may be advantageous to provide a support component, for example, alumina, that has a higher surface area than the cordierite substrate.

In the context of a structured material assembly, the conductive carbonized network in combination with the substrate and the support component may be referred to herein as an integrated composite.

The sorbent comprises a material or mixture of materials in solid form that can remove CO₂ from a gas source, such as for example a gas source stream, through a mechanism of physical adsorption (e.g., van der Waals forces), chemical adsorption, or combinations of any of the foregoing mechanisms. In embodiments, chemical adsorption is the preferred mechanism of sorption. As used herein, the term “CO₂ sorbent” refers to an active component chemically reacting with CO₂ molecules.

It is generally understood that materials through physisorption such as zeolites, activated carbons, or metal organic frameworks (MOFs) typically perform better at relatively higher CO₂ partial pressures or concentrations generally present for point source emissions. DAC typically involves very low concentrations of CO₂ (e.g., about 415 ppm) at ambient pressure. Chemisorption materials have shown to be more effective as DAC sorbents.

Various capture agents have been considered for use as DAC sorbents. Chemical sorbents with strong CO₂-binding affinities are typically employed for CO₂ capture. Solid inorganic bases as sorbents have also been considered. For example, Ca-based, Mg-based, K-based, and Na-based oxides, hydroxides, and carbonates have been considered. Solid-supported amine materials have also been considered as sorbents for DAC systems. Amine-containing sorbents have been previously divided into three classes: (i) Class 1 sorbents, prepared by impregnating amines into the pores of a support, (ii) Class 2 sorbents, consisting of amines covalently bonded to the walls of porous materials, and (iii) Class 3 sorbents, where amine monomers have been polymerized in-situ, resulting in polyamine structures tethered to the walls of a support.

In embodiments, the CO₂ sorbent may comprise Group 1 elements in periodic table, i.e., an alkali metal, such as lithium, sodium, and potassium, with sodium and potassium being generally preferred. The sorbent may usefully employ alkali metal oxides, hydroxides, carbonates, carbonate hydrates, and bicarbonates. For example, the sorbent may include disodium oxide, sodium hydroxide, sodium carbonate, sodium carbonate hydrate(s), sodium sesquicarbonate dihydrate, and potassium carbonate, potassium carbonate hydrate and, potassium sesquicarbonate sesquihydrate, and a combination thereof. The sorbent may employ alkali metal compounds such as sodium aluminate, sodium silicate, sodium phosphate, potassium aluminate, potassium silicate, and potassium phosphate.

Alternatively, the CO₂ sorbent may comprise Group 2 elements in periodic table, i.e., an alkaline earth metal, such as magnesium, calcium, and barium, with calcium and magnesium being preferred, and calcium most preferred. The sorbent may comprise alkaline earth metal oxides and hydroxides, and carbonates. For example, the sorbent may include calcium oxide, calcium hydroxide, calcium carbonate, magnesium oxide, magnesium hydroxide, magnesium carbonate, and barium carbonate or a suitable combination thereof. The sorbent may employ alkaline earth compounds such as calcium aluminate and calcium silicate.

In various embodiments, the CO₂ sorbent may comprise at least one of sodium oxide, sodium carbonate, calcium oxide, calcium carbonate, potassium carbonate, magnesium oxide, magnesium hydroxide, magnesium carbonate, barium oxide, and barium carbonate. In various embodiments, the CO₂ sorbent comprises at least one of sodium oxide and sodium carbonate. In other embodiments, the CO₂ sorbent comprises sodium carbonate.

The CO₂ sorbent may comprise other sorbent species or additives or promoters of any suitable type or types. For example, the sorbent may comprise lithium salts, piperazine, amino acids, amino acid salts, and ionic liquids. The amino acid salt may comprise one or more of sodium lysinate, potassium lysinate, lithium lysinate, potassium glycinate, sodium glycinate, lithium glycinate, histidine sodium salt, taurine sodium salt, aspartic acid sodium salt, asparagine sodium salt, alanine sodium salt, leucine sodium salt, or taurine potassium salt.

The CO₂ sorbent in the structured material assembly may be present in any suitable amount that is effective for CO₂ removal in exposure of the sorbent to ambient air, point source emissions, or other gases containing CO₂. In various embodiments, the CO₂ sorbent is present in the structured material assembly in an amount ranging from 5 to 50% by weight, based on total weight of the structured material assembly, although the present disclosure is not limited thereto. In embodiments, the CO₂ sorbent may be present in an amount of from 5 to 50% by weight, 10 to 40% by weight, 15 to 35% by weight, and 10 to 30% by weight, based on total weight of the structured material assembly. For example, the CO₂ sorbent may be present in an amount of 20, 25, and 30% by weight.

In embodiments, the CO₂ sorbent may be deposited on or in the support component, which may include, without limitation, alumina, titania, silica, zirconia, and combinations thereof. It can be helpful for the sorbent to be supported on a material having higher surface area than that of the substrate material. For example, a cordierite monolith generally has a low surface area. Thus, for a sorbent deposited on a cordierite substrate, it may be advantageous to provide a support component for the sorbent to be deposited on, for example, alumina, that has a higher surface area than the cordierite of the substrate. The combined sorbent and support can be deposited on or in the substrate having relatively low surface area, e.g., cordierite.

The substrate, the CO₂ sorbent (optionally deposited on or in a support), and the desorption material are arranged such that the substrate is in a structural supporting relationship with the sorbent and the desorption material. For example, in embodiments, the sorbent may be deposited on (e.g., washcoated on) or in (e.g., impregnated into) the substrate, and the desorption material may be deposited on (e.g., washcoated on) or in (e.g., impregnated into) the substrate. The substrate may have a monolithic form or laminate form, or 3D printed form.

In embodiments wherein the substrate is produced independently, the sorbent, the support, and the desorption material may be deposited in or on the substrate sequentially or simultaneously and independently or in combination. For example, a slurry form of the support material could be applied onto the substrate followed by a slurry form of the desorption material, further followed by applying a slurry form of the sorbent material. In this example, the support, the desorption material, and the sorbent are applied independently and sequentially. In another example, a slurry of the support material is first applied in or on the substrate followed by separate slurries of sorbent and desorption material applied onto the substrate at the same time. In this example, the support is applied independently to the substrate, and the sorbent and the desorption material are applied independently but simultaneously to the support material on the substrate. In a further example, a slurry of the support material is first applied to the substrate, followed by a slurry comprising a combination of the sorbent and the desorption material. In this example, the sorbent and the desorption material are applied in combination, simultaneously, but sequentially to the support material.

In embodiments wherein the substrate is produced independently, the sorbent and the desorption material may be applied in or on the substrate sequentially or simultaneously and independently or in combination without a sorbent support material. For example, a slurry form of the desorption material could be applied onto the substrate followed by a slurry form of the sorbent. In this example, the sorbent and the desorption material are applied independently and sequentially. In another example, a slurry of the sorbent and a separate slurry of the desorption material could be applied onto the substrate at the same time. In this example, the sorbent and the desorption material are applied independently but simultaneously. In a further example, a slurry comprising a combination of the sorbent and the desorption material could be applied to the substrate. In this example, the sorbent and the desorption material are applied in combination, but simultaneously.

In embodiments wherein the substrate is produced independently, the sorbent, the support, and the desorption material may be deposited in or on the substrate sequentially or simultaneously and independently or in combination. In embodiments wherein the desorption material is a conductive carbon network formed as described above, intermediate curing and pyrolyzing of the phenolic resin may take place as well. Additionally, intermediate calcining of the support material may take place. Calcining can aid in binding the support to the substrate and opening pores of the support. In embodiments, the support material is generally available as a solid and transformed into a slurry form for coating. For example, alumina powder may be suspended in water to create a slurry form. In embodiments where the desorption material precursor is phenolic resin, the desorption material precursor is generally available as a liquid and the sorbent is generally available as a solid and transformed into a solution form. For example, for the desorption material precursor, phenolic resin may be dissolved in or suspended in water, and for the sorbent, it may be dissolved in or suspended in water. As mentioned previously, the CO₂ sorbent may comprise various sorbent species, additives, or promoters of any suitable type or types. For example, the sorbent may comprise lithium salts, piperazine, amino acids, and ionic liquids.

In embodiments wherein the substrate is produced independently, the desorption material, the support, and the sorbent may be applied in or on the substrate sequentially or simultaneously and independently or in combination.

It will be understood by a person having ordinary skill in the art that when the terms dispersing, coating, applying, and the like are used, the component being dispersed, coated, or applied is in a form suitable for such application. For example, when a phenolic resin is being dispersed, coated, or applied it will be in a suitable form for the processing step, such as, for example, solution form or slurry form. In another example, when a sorbent is being dispersed, coated, or applied, it will be in a suitable form for the processing step, such as, for example, solution form.

Advantageously, when the desorption material is a conductive carbon network formed as described above, the desorption material and the support can be applied to the substrate and processed to form an integrated composite before the sorbent is added. Adding the sorbent after the other components avoids the sorbent having to go through extreme heat processing of curing, calcining, and pyrolysis, which enables using a broader range of sorbents, for example, sorbents that cannot withstand higher temperatures, such as organic sorbents.

In embodiments, a slurry or solution of a desorption material precursor, such as a phenolic resin, could be applied onto the substrate. Then the substrate with the desorption material precursor could be cured and pyrolyzed. Then a support slurry could be applied to the desorption material and substrate, which could then be heat treated in an inert environment or calcined in an air environment to produce an integrated composite. Then the sorbent can be applied to the integrated composite after it has been produced. In this manner, any sorbent that is suitable for CO₂ capture can be added to the integrated composite after the integrated composite has been produced as opposed to forming a continuous body of sorbent and carbon as known in the art.

Sorbents that are components of green bodies must be able to withstand high temperatures necessary for pyrolysis and/or firing of the green body, which excludes most organic sorbents, many of which are recognized to be high performing and low energy CO₂ sorbents.

Alternatively, a slurry or solution of a desorption material precursor could be applied onto a substrate. Then the substrate with the desorption material precursor could be cured. Then a support slurry could be applied to the cured substrate, which could then be heat treated in an inert environment for pyrolysis to form the integrated composite. Then the sorbent can be applied to the integrated composite after it is produced.

In a further example, a mixture containing both the support material and the desorption material precursor are first applied to a substrate. The coated substrate can then be dried, and heat treated (i.e., cured and calcined) in an inert environment. The sorbent can then be coated on to or into the integrated composite.

For example, a slurry of the support material could be applied onto the substrate followed by a slurry or solution of the desorption material, further followed by applying a slurry or solution of the sorbent material. In this example, the support, the desorption material, and the sorbent are applied independently and sequentially. In another example, a slurry of the support material is first applied in or on the substrate followed by separate slurries or solutions of sorbent and desorption material applied onto the substrate at the same time. In this example, the support is applied independently to the substrate, and the sorbent and the desorption material are applied independently but simultaneously to the support material on the substrate.

In embodiments wherein the substrate is produced independently, the sorbent and the desorption material may be applied in or on the substrate sequentially or simultaneously and independently or in combination without a sorbent support material. For example, a slurry form of the desorption material could be applied onto the substrate followed by a slurry form of the sorbent. In this example, the sorbent and the desorption material are applied independently and sequentially. In another example, a slurry of the sorbent and a separate slurry of the desorption material could be applied onto the substrate at the same time. In this example, the sorbent and the desorption material are applied independently but simultaneously. In a further example, a slurry comprising a combination of the sorbent and the desorption material could be applied to the substrate. In this example, the sorbent and the desorption material are applied in combination, but simultaneously.

In alternative embodiments, the substrate and desorption materials may be combined, for example in a paste and extruded together in a combined article. In this embodiment, the desorption material may be dispersed throughout the substrate when the combined article is extruded into a monolithic form to achieve the desired physical, structural, and electrical properties. The support material may then be applied, optionally, as a washcoat on to the combined article. The sorbent may then be applied, either on to (washcoated) the support or in to (impregnated) the support to create the structured material assembly.

In alternative embodiments, the substrate and desorption materials may be combined, for example in a paste and extruded together in a combined article. In this embodiment, the desorption material may be dispersed throughout the substrate when the combined article may be extruded into monolithic form to achieve the desired physical, structural, and electrical properties. The sorbent may then be applied without a support material, either on to (washcoated) or in to (impregnated) the combined article to create the structured material assembly.

In alternative embodiments, the substrate, sorbent, and desorption material may be combined, for example in a paste and extruded together in a single combined article. In this embodiment, the sorbent and desorption materials may be dispersed throughout the substrate when the combined article is extruded into monolithic form to create the structured material assembly.

In alternative embodiments with wire mesh laminates, the substrate and desorption material may be produced as a single combined article and produced by spinning, weaving, or 3D printing a metal wire or powder into a structure. The support material may then be added onto the substrate (e.g., washcoating) and the sorbent material may then be added on or in the support to create the structured material assembly.

In various embodiments, the CO₂ sorbent and desorption material may be combined such that in combination with one another they form a self-supporting material body, and a substrate is not needed. The CO₂ sorbent may be doped with the regeneration material in the self-supporting material body, wherein the self-supporting material body may comprise a monolith, and the regeneration material may comprise an electrically resistive material, with the structure material assembly having an electrical resistivity in a range of from 0.03 to 300 Ω-m. The structured material assembly may further comprise electrodes in contact with the monolith to pass electrical energy through the monolith to responsively generate the in-situ heat by the regeneration material therein for Joule heating of the CO₂ sorbent to desorb adsorbed CO₂ from the CO₂ sorbent, after adsorption of CO₂ by the CO₂ sorbent.

In still other embodiments, the structured material assembly is constituted, as comprising a laminate comprising sheets of the regeneration material coated with the CO₂ sorbent, wherein the regeneration material comprises carbon, wherein adjacent sheets of the laminate are in contact with each other through an insulating material to prevent short circuiting, and wherein sheets of the laminate have electrical connections at respective spaced-apart portions thereof, with electrical connections at corresponding ones of the respective spaced-apart portions of the sheets being electrically coupled to form a positive electrode of the laminate, and with electrical connections at corresponding others of the respective spaced-apart portions of the sheets being electrically coupled to form a negative electrode of the laminate, wherein when the positive electrode and the negative electrode are coupled with an electrical energy source in circuit-forming relationship, electrical current flows between the electrodes through the sheets in the laminate.

In various embodiments, the structured material assembly may comprise a monolith of a mixture of the CO₂ sorbent and the regeneration material. The structured material assembly may for example be formed as an extrudate of the mixture of the CO₂ sorbent and the regeneration material. The regeneration material in such structured material assembly may comprise an electrically resistive material responsive to applied electrical energy to generate the in-situ heat to desorb adsorbed CO₂ from the sorbent in the structured material assembly, e.g., electrically resistive material comprising carbon material.

Additionally, or alternatively, the structured material assembly comprising a monolith of a mixture of the CO₂ sorbent and the regeneration material may comprise a material responsive to microwave radiation to generate the in-situ heat to desorb adsorbed CO₂ from the sorbent in the structured material assembly.

In a further implementation, the structured material assembly may comprise a 3D-printed substrate structure with multiple parallel channels (to enable a low pressure drop for the inlet CO₂-containing stream), which can contain the CO₂ sorbent and the regeneration material thereon. The substrate structure may be formed of a material which can be 3D printed and can provide surface area for the desorption material and CO₂ sorbent material, e.g., polymer, plastic, metal, ceramic material, and/or composite material. In such assembly, the regeneration material may comprise (i) an electrically resistive material responsive to applied electrical energy to generate the in-situ heat to desorb adsorbed CO₂ from the sorbent in the structured material assembly, and/or (ii) a material responsive to microwave radiation or radio frequency energy to generate the in-situ heat to desorb adsorbed CO₂ from the sorbent in the structured material assembly. The foregoing structured material assembly may be constituted, wherein the CO₂ sorbent and the regeneration material are impregnated into the walls of the 3D printed substrate material structure. Alternatively, the assembly may be constituted, wherein the regeneration material is washcoated onto the 3D printed substrate material structure in a layer of the regeneration material, and the CO₂ sorbent is further added on or in the layer of the regeneration material to create the structured material assembly.

In alternative embodiments, a 3D printed structured material assembly may comprise a composite of substrate materials that contains a portion of soluble components and a portion of non-soluble component that are 3D printed together into a structure. Prior to adding the desorption material and CO₂ sorbent material to the composite substrate, the soluble component of the 3D printed substrate structure can be removed through dissolution, e.g., water or other solvent, which increases the surface area for desorption material and CO₂ sorbent material and lowers the mass of the substrate structure, reducing heating losses. The desorption material and sorbent material could be impregnated into pores of the non-soluble portion of the 3D printed substrate structure walls created by removed soluble material to produce the structured material assembly.

The 3D printed structured material assembly in other forms may comprise 3D-printed layers of each of the regeneration material and the CO₂ sorbent on a 3-D printed substrate structure with open channels for CO₂ source stream flow.

Another implementation of the structured material assembly as variously described herein includes a substrate having desorption material deposited therein or thereon, wherein the substrate is in a form comprising fluid channels therein, with the structured material assembly further comprising electrodes, wherein at least a portion of the electrodes is in contact with the regeneration material so that electricity can be converted to heat for regeneration of the CO₂ sorbent material and CO₂ is desorbed from the sorbent.

The electrodes may be formed of any suitable material, as for example material having a resistivity that is less than 0.01 Ω-cm. The structured material assembly may further comprise an electrical power supply coupled in circuit relationship with the electrodes, and configured to apply suitable voltage to the electrodes, as for example in a range of 5 to 1,000 V, more preferably in a range of from 100 to 500 V, and most preferably between 400 and 500 V, although the disclosure is not limited thereto. The electrical power supply may more specifically be configured to generate desired amount of current in the circuit of a single structured material assembly with the electrodes, which may for example be in a range of from 0.1 to 20 amperes, and more preferably in a range of from 1 to 10 amperes, although the disclosure is not limited thereto.

In embodiments with monolith forms, the structured material assembly may further comprise electrical connections to the regeneration material to input electrical energy thereto. A connection material may be added as a layer to ends of the SMA (inlets and outlets of channels) having higher electrical conductivity than the desorption material to equalize the electrical potential across the end faces of the monolith. Examples of this connection material layer may include conductive paints, adhesives, epoxies, and like, which could contain metals or inorganic conductive materials such as silver, nickel, copper, and/or carbon as illustrated in Example 4 of this disclosure.

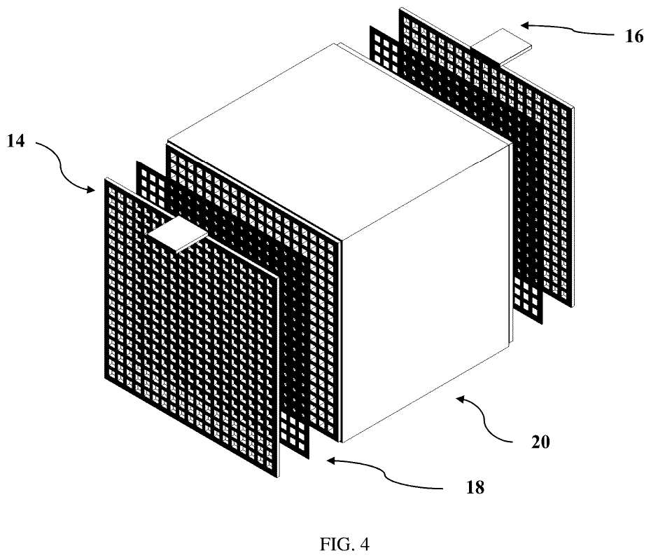

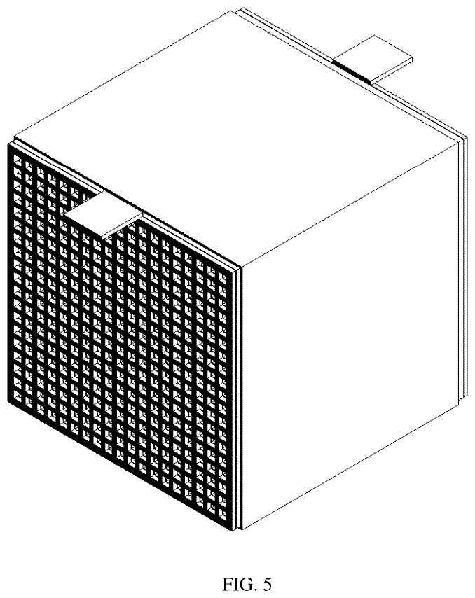

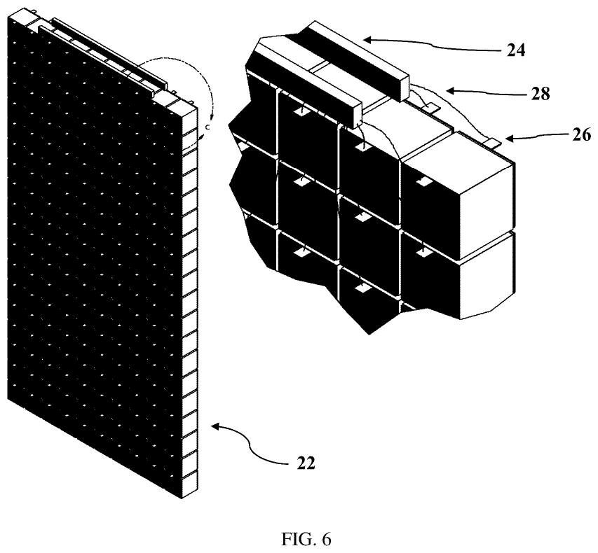

Electrodes and/or wire mesh may be suitably connected to the SMA with the connection material in a manner as to not obstruct the air flow channels while forming a closed circuit to provide electrical current and voltage to the SMA to create a flow through electrode. In embodiments, the electrodes are of higher conductivity than the SMA and may be made of metal such as copper, aluminum, steel, and/or tin. FIGS. 4 and 5 show a drawing of the SMA with electrical connections. The electrodes may be connected via cables or wires to a busbar which may be connected to a power supply or suitable source of power. FIG. 6 shows an example of this electrical connection. An exemplary power supply is a direct current (DC) supply. As will be understood by a person of skill in the art, other sources of power may be used.

In exemplary embodiments, an electrical system can include a wide variety of systems including but not limited to voltage transformers, DC power supplies or variable AC power supplies (VARIAC) although DC power supplies are the preferred method of power delivery to the SMA. The systems and components within the electrical system serve to provide the desired current and voltage to each SMA from the source of electricity, be that utility grid, micro-grid, AC source on-site, DC source on-site, or any other source of electricity.

In embodiments with laminate forms, the structured material assembly may further comprise electrical connections to the regeneration material in input electrical energy thereto. A wire of suitable gauge to safely transmit the electrical current to the desorption material is connected to the laminate end through physical connection such as, for example, solder or mechanical compression to create a terminal. At the opposite end of the laminate, a similar connection is made for the opposite polarity electrical connection, and both wires are terminated to a power supply which outputs electricity.

In embodiments with wire mesh forms, the structured material assembly may further comprise electrical connections to the regeneration material to input electrical energy thereto. A wire of ample gauge to safely transmit the electrical current to the desorption material is connected to the wire mesh end through physical connection such as solder or mechanical compression to create a terminal. At the opposite end of the wire mesh, a similar connection is made for the opposite polarity electrical connection, and both wires are terminated to a power supply which outputs electrical current and voltage.

In embodiments with 3D printed forms, the structured material assembly may further comprise electrical connections to the regeneration material to input electrical energy thereto. An electrode terminal may be 3D printed with the substrate structure to create positive and negative electrode terminals. Wires of ample gauge to safely transmit the electrical current to the desorption material are connected to the 3D printed form and to the power supply which outputs electrical current and voltage.

Multiple structured material assemblies with electrodes can be arranged either in parallel circuits or series circuits, or a combination of parallel and series circuits regarding the electrical power supply.

In a further aspect, the disclosure relates to an integrated CO₂ capture method, wherein the substrate in a structured material assembly provides multiple functions. A substrate herein may be in the form of monolith, laminate, wire mesh, or 3D printed. As an example, a carbon-ceramic monolith as a substrate may be used, first to provide a structure which has multiple parallel channels for low pressure drop during adsorption step, second to provide a high surface area support for the CO₂ sorbent, and third to provide heat for regeneration through electrical heating without adding an additional regeneration material. In this example, monolith may be substituted by a wire-mesh laminate to provide the combined functionality. Additionally, electrical heating may include resistive heating, microwave heating or heating by radio frequency. Any suitable substrate compositions may be used which provide this combined functionality without limiting this disclosure to any specific materials.

In a further aspect, the disclosure relates to a method of reducing the CO₂ content of a CO₂-containing gas mixture. The CO₂ containing gas mixture may comprise ambient air, point source emissions, or other CO₂ containing gas mixtures. The method may be modified or optimized as needed depending on the application. The method comprises contacting the CO₂-containing gas mixture with the CO₂ sorbent in the structured material assembly, as variously described herein, to adsorb CO₂ on the CO₂ sorbent to produce a CO₂-reduced gas effluent that is recovered from the contactor. When the CO₂ sorbent has become loaded with adsorbed CO₂ to a predetermined extent, contacting is terminated, and CO₂ sorbent is regenerated by applying energy to the regeneration material to cause it to responsively generate in-situ heat to desorb previously adsorbed CO₂ from the CO₂ sorbent to produce an effluent gas essentially containing CO₂.

In a further aspect, an SMA or SMA system can further include a motive fluid driver to pull air through the assembly. The motive fluid driver may be of any suitable type, and may for example comprise a pump, fan, compressor, turbine, or other device that is suitable for supplying ambient air to the structured material assembly. An SMA system can also include downstream processing of CO₂, which may include some cooling of the recovered CO₂ from the desorption step and moisture removal and compression to meet the process specifications of its end use which can include but is not limited to conversion into value-added products, sequestration, and/or mineralization.

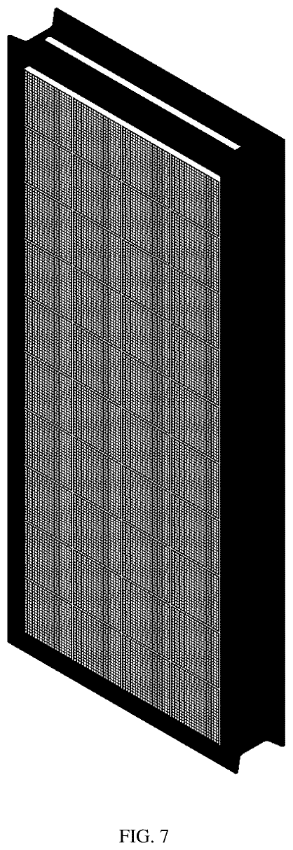

Such method may be carried out in a multiple structured material assembly system in which each structured material assembly in the system contains the CO₂ sorbent, wherein the steps of contacting the CO₂-containing gas mixture with the CO₂ sorbent to adsorb CO₂ and regenerating the CO₂ sorbent when it has become loaded with adsorbed CO₂ to a predetermined extent, are carried out cyclically, alternatingly, and repetitively in each structured material assembly, in continuous operation with at least one structured material assembly in an on-stream contacting mode and with at least one other structured material assembly in a regenerating or standby mode, and wherein each of the structured material assemblies in the multiple structured material assembly system are periodically switched between contacting and regenerating modes in the continuous operation. An example of a SMA system containing multiple SMAs is provided in FIG. 7.

In an exemplary cyclic process, phases or steps may include (1) adsorption, in which air is passed through the structure and CO₂ is captured, (2) purge, wherein the module including the structured material assembly is sealed and non-desirable components of air are removed from the module void spaces, and (3) desorption, wherein electricity or other energy is supplied to heat the CO₂ sorbent, with CO₂ being desorbed and recovered as a product.

The method may be carried out, wherein the CO₂-containing gas mixture primarily comprises ambient air, also known as Direct Air Capture of CO₂ (DAC). The adsorption step of the process may be carried out in a wide range of temperatures and relative humidities, −20° C. to 50° C. and 10% to 100%, respectively, such that the system is deployable globally and can remove CO₂ from ambient air. The ambient air may be forced through the structured material assembly with a fan or other air movement device at a space velocity at the CO₂ sorbent between 5 and 500 hr⁻¹ weight hourly space velocity (WHSV) which is defined as the mass flow rate of ambient air divided by the mass of the CO₂ sorbent material with any support material (but not substrate). In embodiments, the ambient air may be moved through the structured material assembly with less than 350 Pascal (Pa) pressure drop due to the multitude of parallel channels for air flow. In embodiments, the parallel channels may be identical.

In a further specific aspect, the present disclosure relates to a structured material assembly used in the said method for Direct Air Capture of CO₂. In use, the structured material assembly can have a contacting or adsorption mode of operation and a desorption or regeneration mode of operation. The contacting mode for the SMA may be completed when the CO₂ sorbent material reaches a CO₂ capture working capacity ranging from, for example, 0.5 wt % to 15 wt %, where wt % is defined as mass of CO₂ captured in a cycle per mass of CO₂ sorbent material and any support material.

In a further specific aspect, the structured material assembly used in the said method of Direct Air Capture of CO₂. At the completion of the CO₂ capture step, the structured material assembly may be purged with a gas or evacuated with a pump or blower to remove or reduce the components of ambient air such as nitrogen, oxygen, and argon to a level low enough to meet a final CO₂ product specification.

In a further specific aspect, the structured material assembly can be used in a method of Direct Air Capture. Electrical energy is inputted to the structured material assembly to heat the CO₂ sorbent and desorb the captured CO₂ while regenerating the sorbent material at a temperature less than 120° C. in less than 5 minutes. The CO₂ which is released from the sorbent material is evacuated from the structured material assembly via vacuum or through a sweep gas and then gathered in tubing or piping and mixed with CO₂ from other structured material assemblies operating in similar sequencing steps. The combined CO₂ can be sequestered or mineralized in suitable geological storage facilities. Optionally, the combined CO₂ can be utilized in a process to create sustainable fuels or chemicals or other value-added products. The number of structured material assemblies can easily be modified and designed to accommodate the desired CO₂ removal rate.

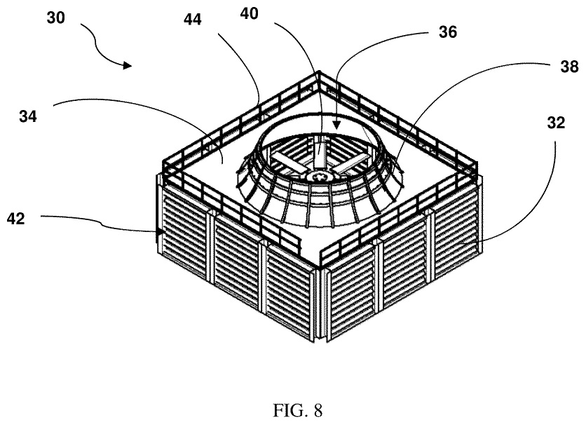

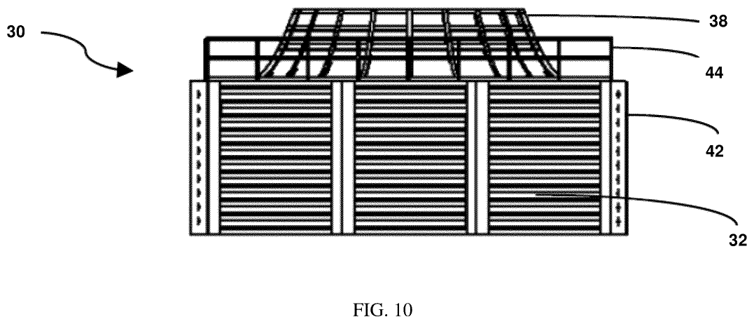

The direct air capture CO₂ removal system can in various embodiments comprise multiple modules each containing a multitude of the structured material assemblies, wherein the multiple modules are arranged together by mechanical supports with common inlet and outlet manifolds that are constructed and arranged for cyclic alternating and repetitive operation in which each of the multiple vessels performs successive (i) CO₂ removal, and (ii) CO₂ desorption with in-situ heating within the structured material assembly, in the cyclic alternating and repetitive operation. Example designs of the air contactor containing multiple modules of SMA are provided in FIGS. 8 and 10.

In a further specific aspect, the present disclosure relates to a structured material assembly comprising a Na₂CO₃-based sorbent with a combined article of desorption material and substrate in the form of a carbon-ceramic monolith substrate, constructed and arranged for (i) direct air contacting of the sorbent to remove CO₂ from the air, and (ii) heating of the assembly so that the regeneration material transmits heat to the sorbent to desorb previously adsorbed CO₂ from the sorbent. In a related aspect, a process of using such structured material assembly is provided, wherein the process includes the steps of (1) adsorption, in which air is contacted with the structured material assembly and CO₂ is captured, (2) purge, wherein the structured material assembly is purged of non-adsorbed air components, and (3) desorption/regeneration, wherein electricity or other energy is supplied to heat the regeneration material so that it transmits heat to the sorbent, with CO₂ being desorbed and recovered from the structured material assembly.

It will be appreciated from the foregoing that the structured material assembly of the present disclosure can be constructed, arranged, and utilized in a wide variety of alternative forms, compositions, systems, and processes, to achieve removal of CO₂ from ambient air or other CO₂-containing gases.

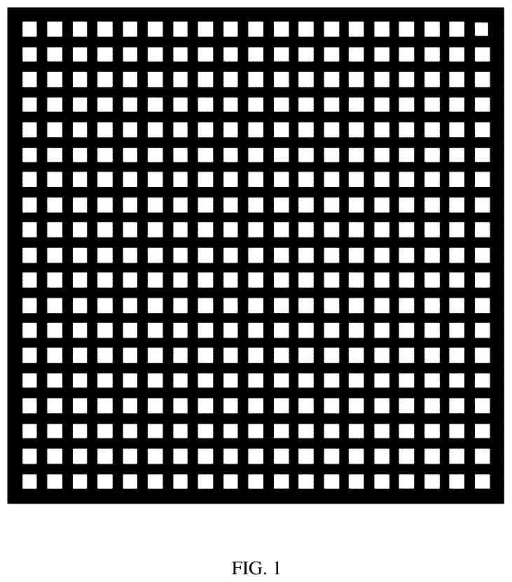

Referring now to the drawings, FIG. 1 provides a schematic of a front cross-section of a monolith substrate highlighting the multitude of channels for air flow and their respective walls wherein sorbent material can be deposited on or in the substrate. In use, the monolithic structured material assembly receives a CO₂-containing stream at an inlet face for flow of the gas through the assembly. The gas flows through flow channels of the substrate, and sorbent in the structured material assembly adsorbs CO₂ from the gas stream. A CO₂-lean gas stream is discharged from outlets of the flow channels of the monolithic assembly at an opposite outlet face.

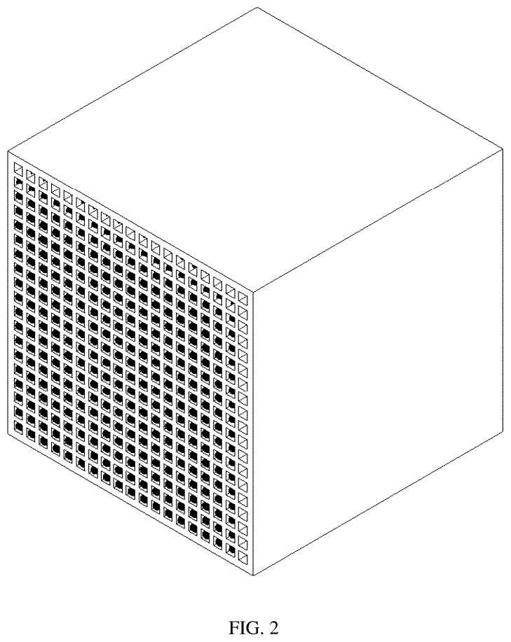

FIG. 2 shows a perspective view of the exemplary monolith substrate schematic in FIG. 1 illustrating a 3-dimensional nature of the substrate material after it has been formed into a structure.

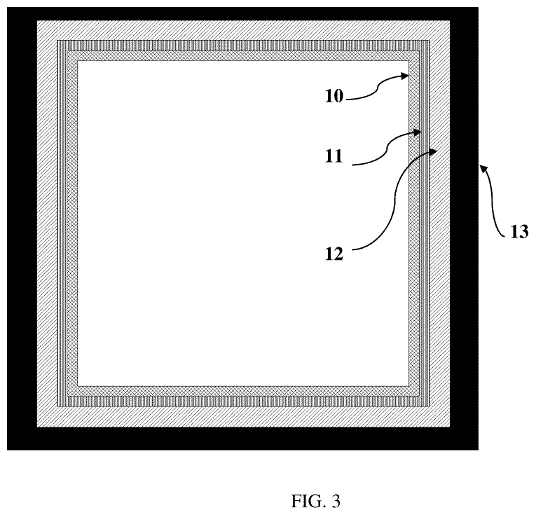

FIG. 3 illustrates a resulting cross-section of an exemplary flow channel of the monolith substrate shown in FIG. 1 with channel walls 13 coated with the sorbent material 10, sorbent support material 11, and desorption material 12.

FIG. 4 presents an exploded view of the exemplary structured material assembly of FIG. 1 illustrating one of several methods of providing desorption energy for desorbing the CO₂ from the sorbent surface during the desorption step such as a pair of electrode plates/wire mesh 14 with connection tabs 16, pair of highly conductive coating connections 18, and the substrate material 20.

FIG. 5 shows an unexploded view of the final SMA with electrical connections.

FIG. 6 shows an arrangement of a multitude of the SMAs shown in FIG. 5 to create a single module 22, the size of which is determined by the target CO₂ removal capacity of a single unit and the cycle design. This design may contain a pair of positive and negative busbars 24 to which the respective positive and negative ends 26 of the SMA may be connected via conductive wires 28 as shown in FIG. 6.

FIG. 7 shows the final module which consists of the enclosure which may house the multitude of SMAs shown in FIG. 6.

FIG. 8 is a perspective view of example air contactor unit 30 of a direct air capture apparatus according to one embodiment of the disclosure. The air contactor unit 30 includes modules (FIG. 7) joined at their side edges to one another to form a closed loop polygon enshrouded by a rectangular enclosure 32 as illustrated. The walls together with a plenum 34 define an enclosed interior volume having a central air outlet port 36 in the top deck, which is circumscribed by an air outlet port shroud 38. The air outlet port 36 partially encloses a fan 40 which drives air through the modules housing the multitude of SMAs. The fan may be powered by a suitable driver, e.g., an electrical motor, turbine, solar-driven engine, or other motive driver.

In operation, ambient air from the environment of the air contactor unit 30 is contacted with the CO₂ sorbent in the structured material assembly as described herein and drawn into the interior volume of the enclosure by operation of the fan 40. The air then flows from the interior volume to produce a CO₂-reduced effluent gas which exits the air contactor unit through the central air outlet shroud and port.

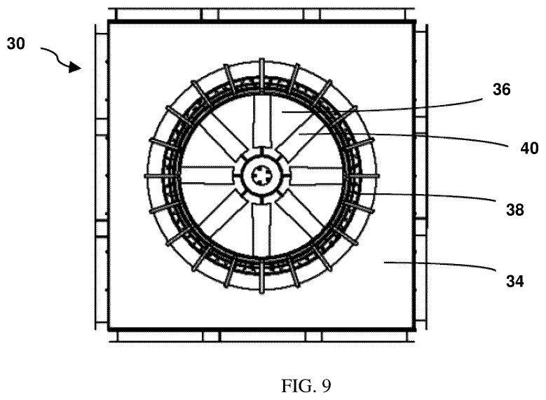

FIG. 9 is a top plan view of the air intake unit 30 shown in FIG. 8, showing the fan 40 centrally deposited in the air from outlet port 36, with the air outlet port 36 being circumscribed by the air outlet port shroud 38 mounted on the plenum 34.

FIG. 10 is a front elevation view of the air contactor unit 30 shown in FIG. 8, depicting the enclosure 32 formed by walls 42, and the grate 44 bounding the top deck around air outlet port shroud 38.

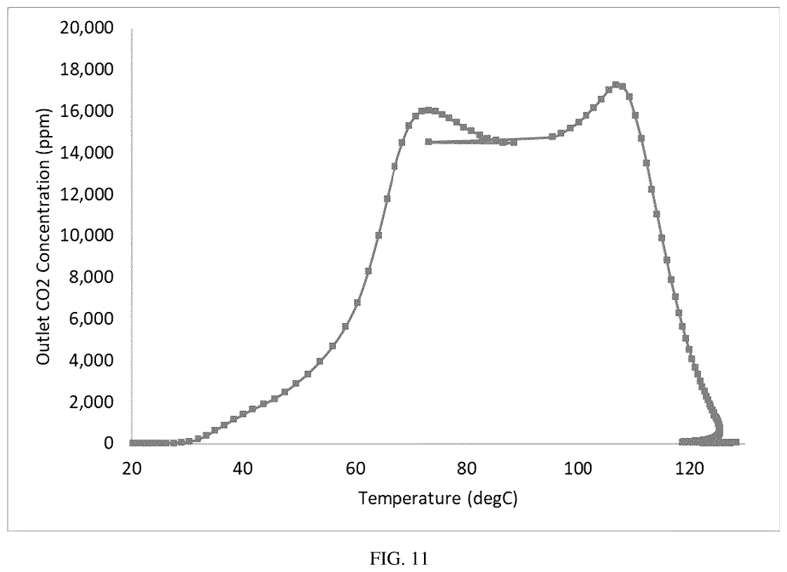

FIG. 11 shows the CO₂ concentration in the reactor effluent gas as a function of temperature during the desorption step for an exemplary structured material assembly comprising a cordierite monolith that was coated with an alumina support, a conductive carbon paint as a desorption material, and Na₂CO₃ as a CO₂ sorbent. The exemplary SMA was used for testing as described in Example 1. Desorption was conducted with a 500 mL/min flow of dry nitrogen.

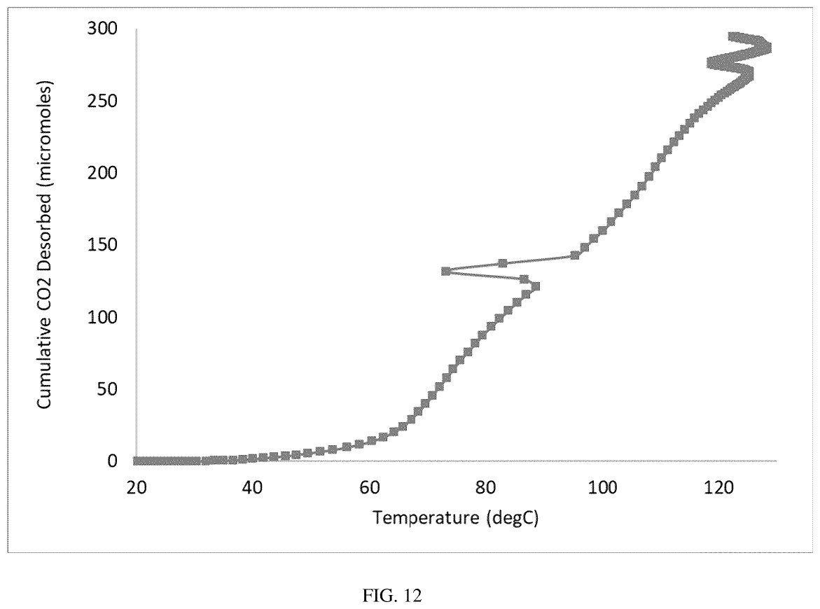

FIG. 12 shows the cumulative CO₂ desorbed as a function of temperature during the desorption step conducted with a 500 mL/min flow of dry nitrogen through the structured material assembly in Example 1. The CO₂ concentration measured in the reactor effluent gas during the desorption step (FIG. 11) was used to calculate the cumulative CO₂ desorption.

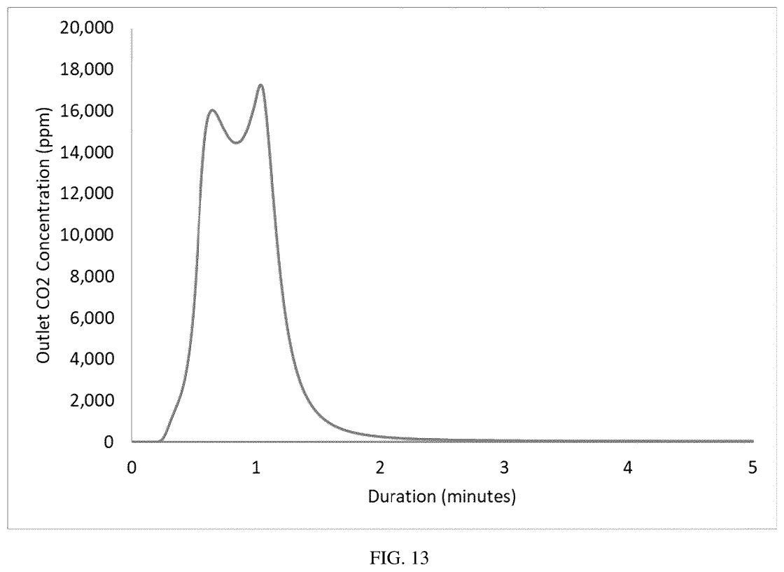

FIG. 13 shows the CO₂ concentration in the reactor effluent gas as a function of time during the desorption step conducted with a 500 mL/min flow of dry nitrogen through the structured material assembly in Example 1. Here the sorbent was resistively heated after undergoing an adsorption step.

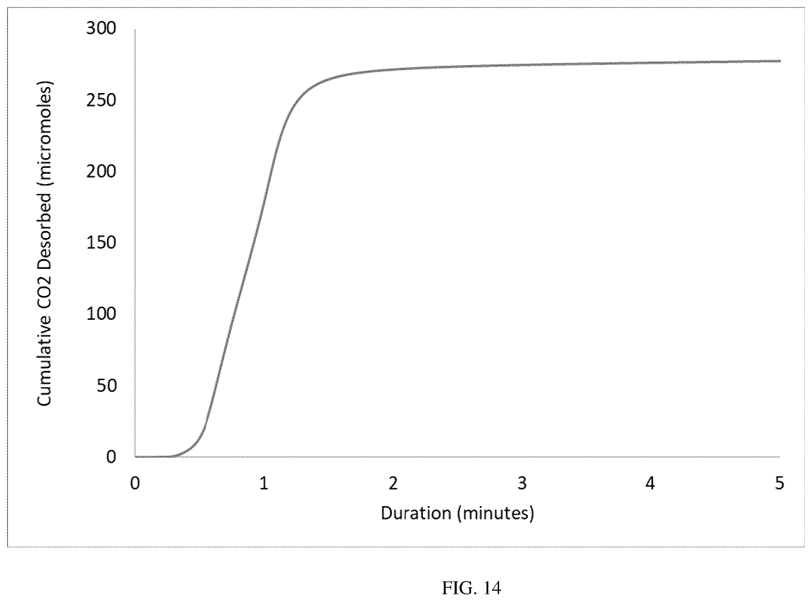

FIG. 14 shows the cumulative CO₂ desorbed as a function of temperature during the desorption step conducted with a 500 mL/min flow of dry nitrogen through the structured material assembly in Example 1. Here the sorbent was resistively heated after undergoing an adsorption step similar to that shown in FIG. 12. The CO₂ concentration measured in the reactor effluent gas during the desorption step (FIG. 13) was used to calculate the cumulative CO₂ desorption.

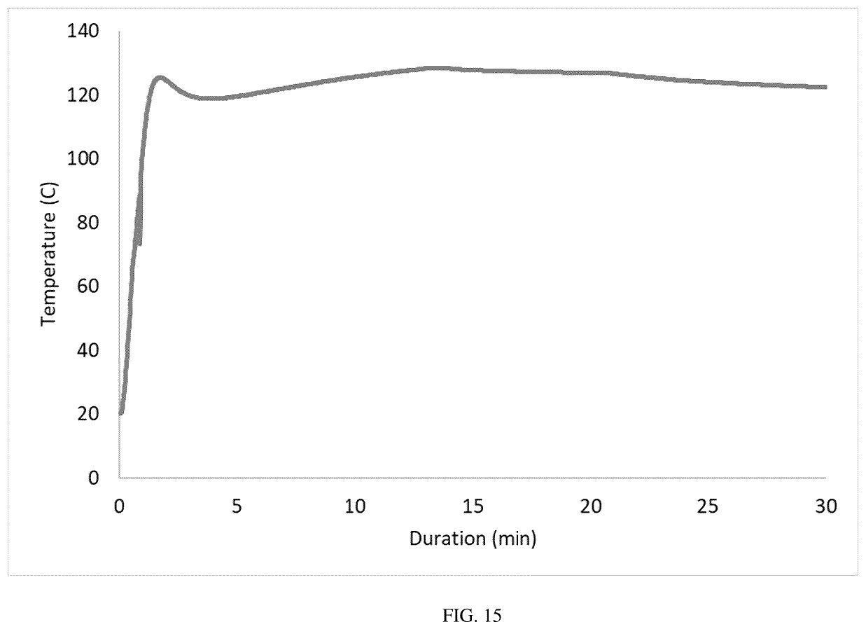

FIG. 15 shows the temperature of the monolith surface during desorption, as measured by a thermocouple attached to the monolith's surface for the structured material assembly in Example 1 wherein the sorbent is resistively heated after undergoing an adsorption step.

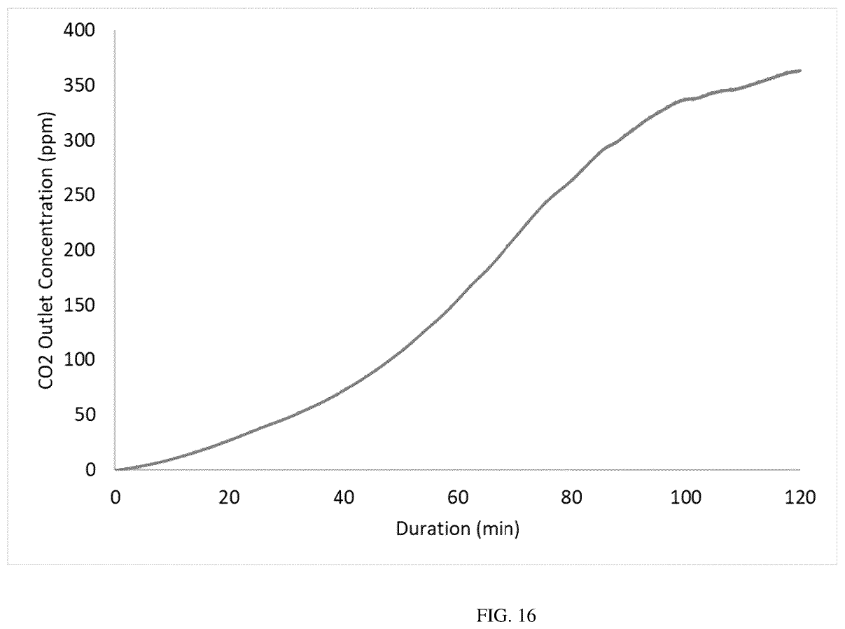

FIG. 16 shows the breakthrough curve for Cycle 4 for a carbon-cordierite composite monolith that is coated with a Na₂CO₃ sorbent of Example 2. Certified air with 393 ppm of CO₂ saturated with water at room temperature at a flow rate of 1000 mL/min through the monolith assembly was used in a sealed reactor. The CO₂ concentration was measured in the reactor effluent gas.

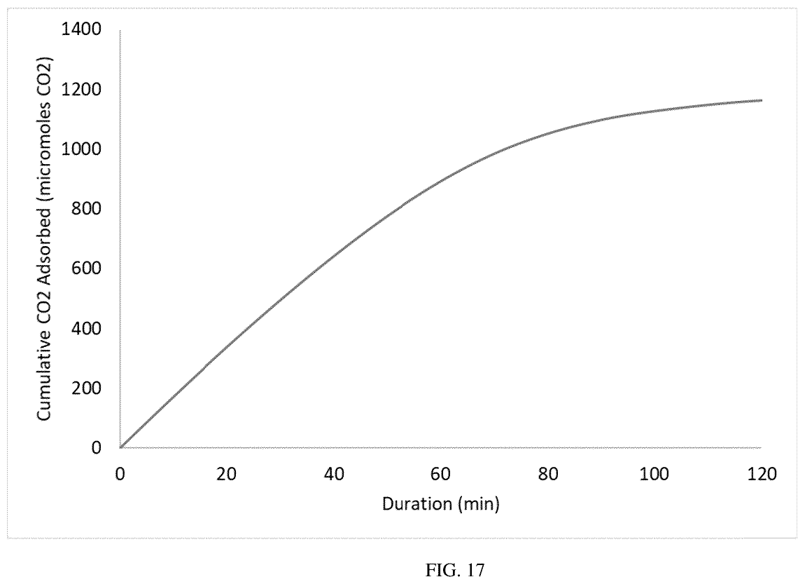

FIG. 17 shows the cumulative CO₂ adsorbed in Cycle 4 by the carbon-cordierite composite monolith coated with a Na₂CO₃ sorbent of Example 2. The measured CO₂ concentration in the reactor effluent was used to calculate cumulative adsorption using the results shown in FIG. 16.

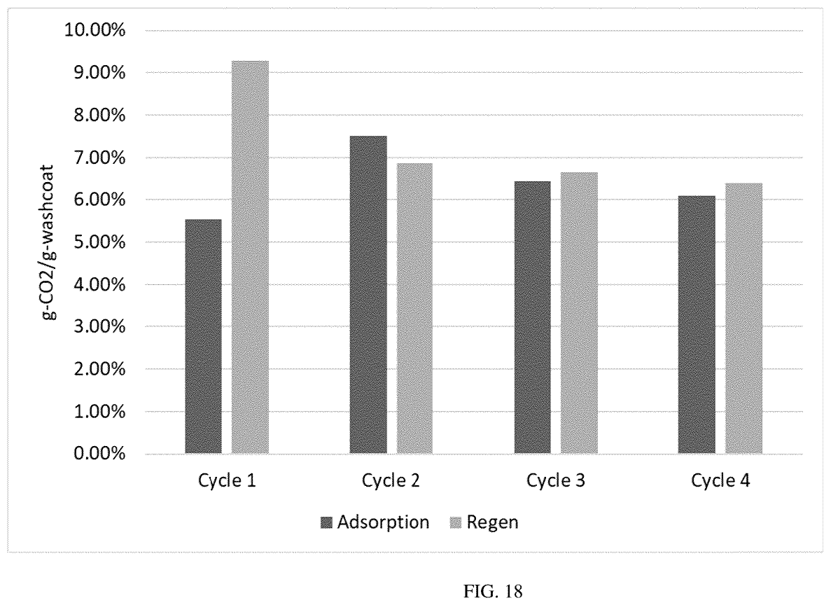

FIG. 18 shows the cumulative CO₂ adsorbed/desorbed (g-CO₂/g-washcoat where the washcoat refers to the sorbent material) over 4 cycles for the exemplary carbon-cordierite composite monolith of Example 2, which was coated with a sorbent, wherein desorption for all 4 cycles was conducted through resistive heating.

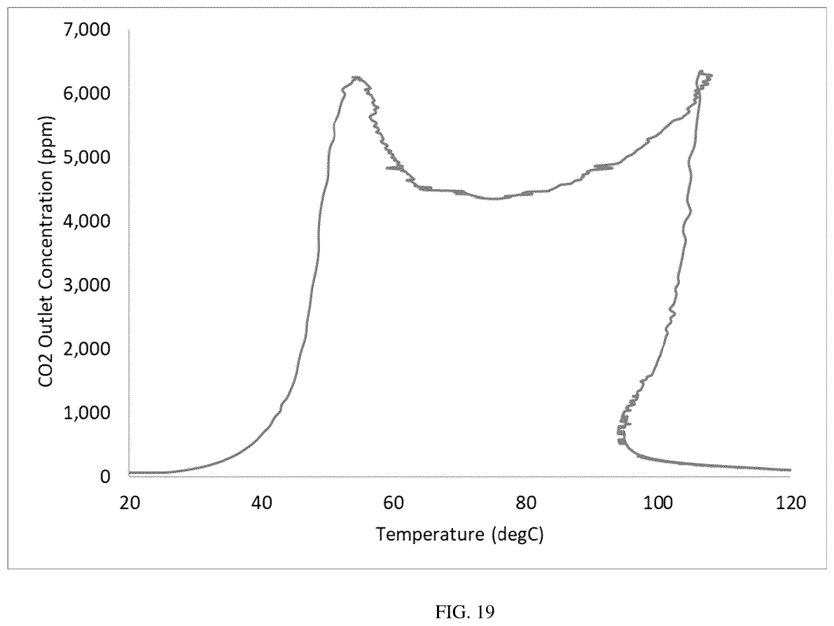

FIG. 19 shows the CO₂ concentration in the reactor effluent gas as a function of temperature during the desorption step conducted with a 1,000 mL/min flow of dry nitrogen through the exemplary carbon-cordierite composite monolith of Example 2. Here the sorbent was resistively heated after undergoing an adsorption step.

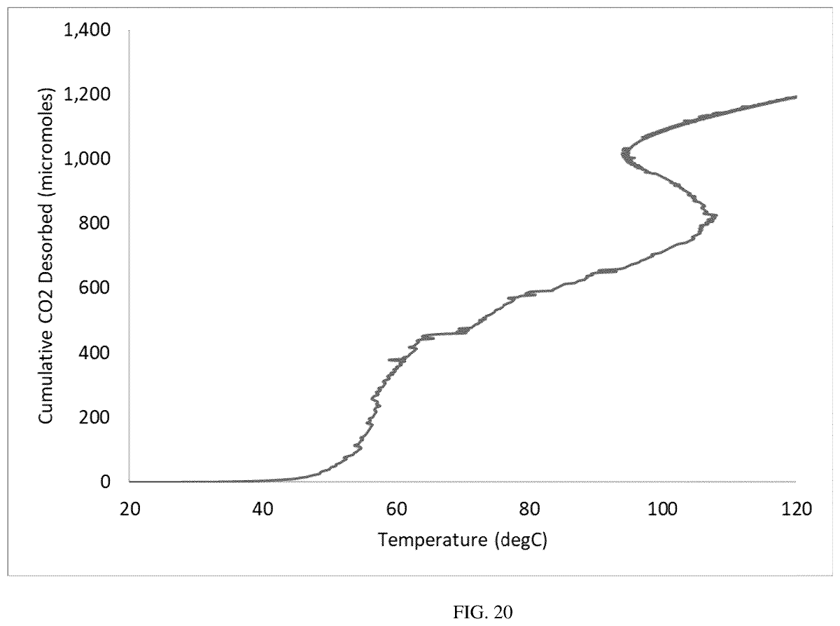

FIG. 20 shows the cumulative CO₂ desorbed as a function of temperature during the desorption step conducted with a 1,000 mL/min flow of dry nitrogen through the carbon-cordierite composite monolith of Example 2. Here the sorbent was resistively heated after undergoing an adsorption step. The CO₂ concentration measured in the reactor effluent gas during the desorption step (FIG. 19) was used to calculate the cumulative CO₂ desorption.

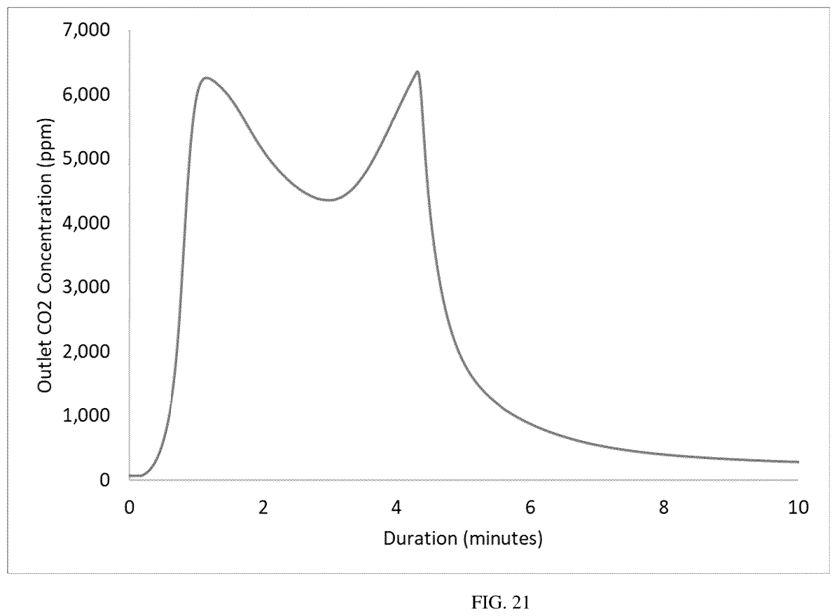

FIG. 21 shows the CO₂ concentration in the reactor effluent gas as a function of time during the desorption step conducted with a 1,000 mL/min flow of dry nitrogen through the carbon-cordierite composite monolith of Example 2. Here the sorbent was resistively heated after undergoing an adsorption step.

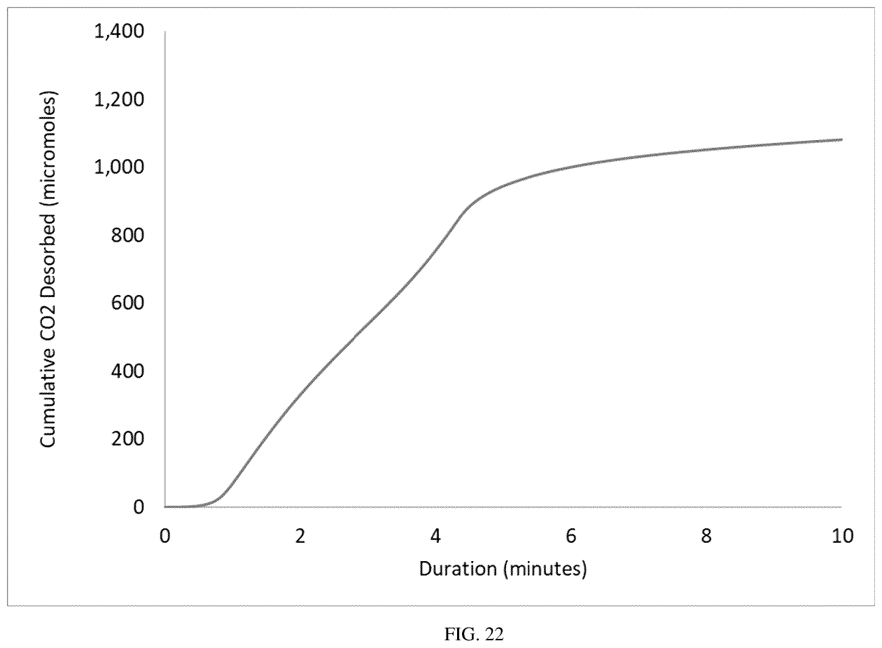

FIG. 22 shows the cumulative CO₂ desorbed as a function of time during the desorption step conducted with a 1,000 mL/min flow of dry nitrogen through the carbon-cordierite composite monolith of Example 2. Here the sorbent was resistively heated after undergoing an adsorption step. The CO₂ concentration measured in the reactor effluent gas during the desorption step (FIG. 21) was used to calculate the cumulative CO₂ desorption.

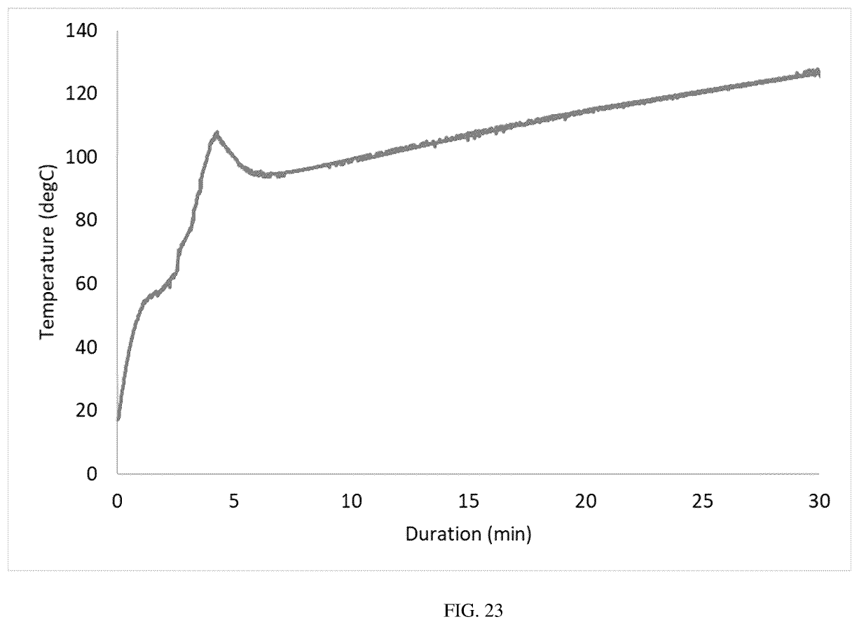

FIG. 23 shows temperature of the monolith surface of the composite monolith of Example 2 during desorption, as measured by a thermocouple attached to the monolith's surface for the carbon-cordierite composite monolith wherein the sorbent is resistively heated after undergoing an adsorption step. Temperature was measured with a fiber optic interrogator system (ODiSI 6000 series, Luna Inc.) capable of measuring temperature along the length of a fiber optic cable with high spatial resolution. The fiber optic cable (<0.2 mm diameter) was woven through the channels to measure temperature while allowing gas flow through the channels (>1 mm diameter).

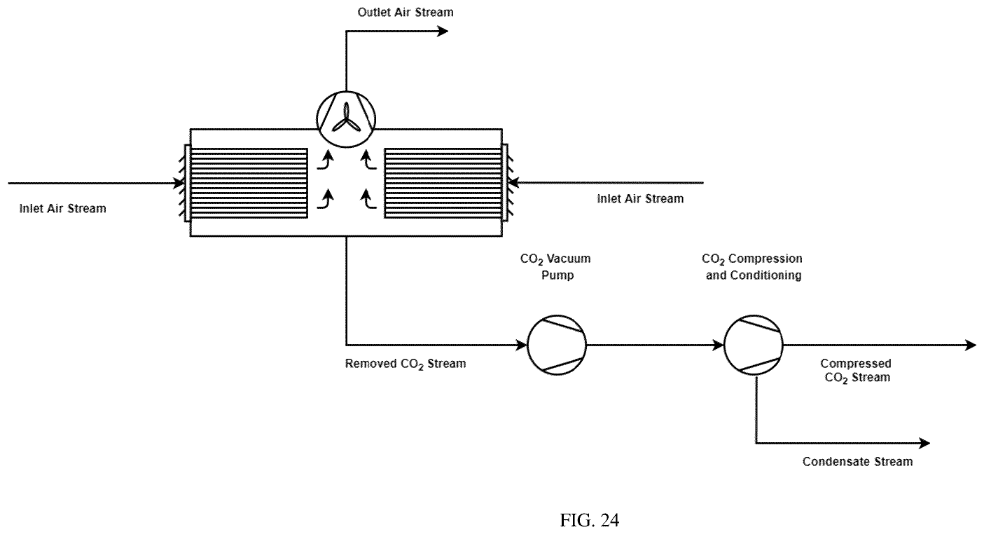

FIG. 24 shows a simplified process flow diagram demonstrating the flow of fresh inlet air which is driven through the multitude of SMAs via a fluid motive driver (a fan is shown), the exit of the CO₂-lean air, and the recovery of the high-purity CO₂ stream which may undergo further conditioning depending upon its disposition options.

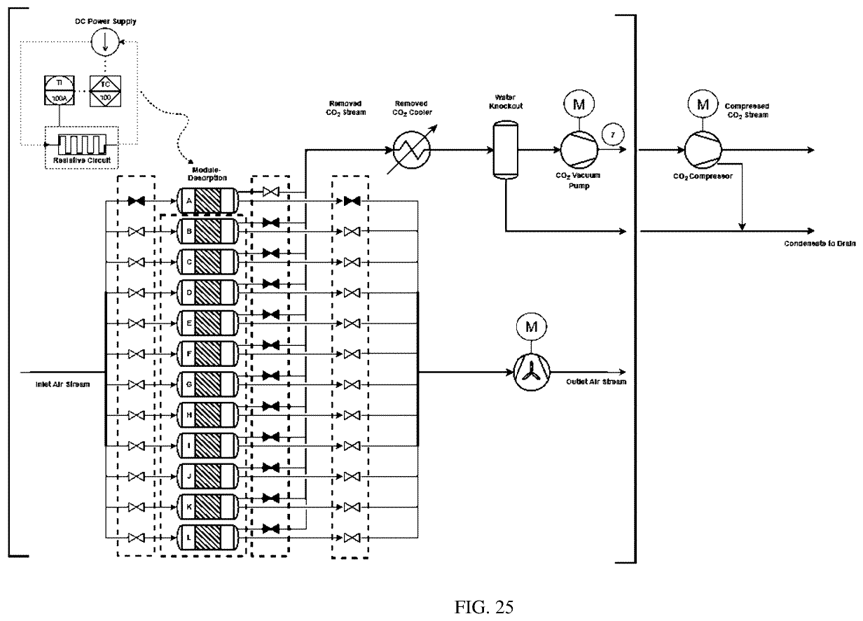

FIG. 25 shows a process flow diagram wherein a system showing 16 modules undergoes a cyclic alternating and repetitive process between the various adsorption, purge, and desorption steps.

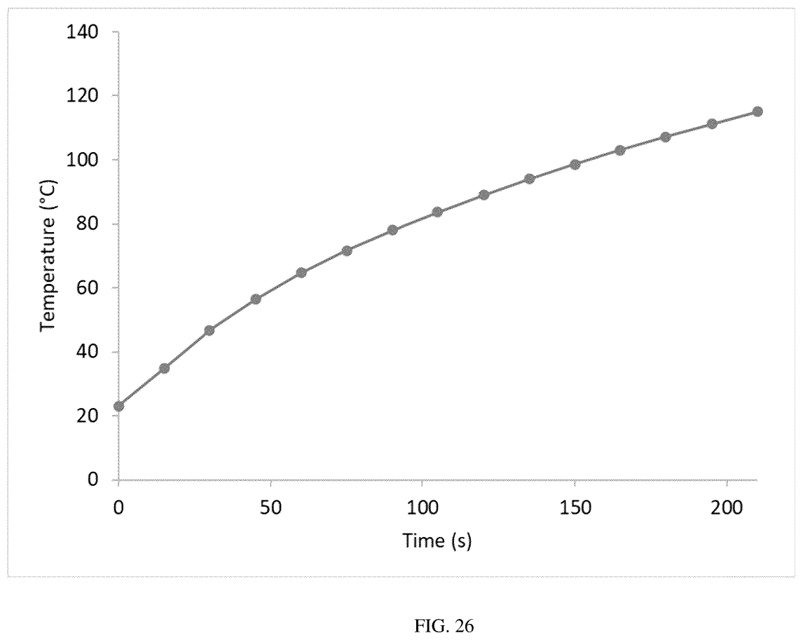

FIG. 26 shows the temperature of the exemplary large (5.9 inch×5.9 inch×3.9 inch) cordierite monolith coated with a conductive carbon layer of Example 3 as it was resistively heated. The temperature shown is the average of 4 thermocouples which were attached to the insulated surface during the measurement.

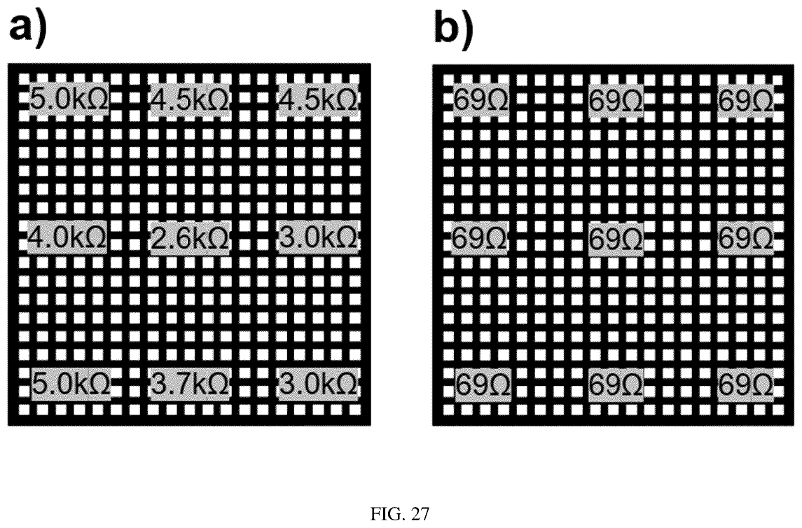

FIG. 27 schematically shows the resistance across a large (5.9 inch×5.9 inch×3.9 inch) cordierite monolith, coated with a conductive carbon layer, as measured with point probes connected to a multimeter (MM400 Digital Multimeter, Klein Tools) in equivalent positions on opposing faces of the monolith. FIG. 27 (a) shows the resistance before any modifications and shows relatively large and varying resistances. FIG. 27 (b) shows the resistance as measured with the multimeter after painting the two faces with a highly conductive silver paint (‘flow-through electrodes’).

In an aspect, a structured material assembly comprises a carbon dioxide (CO₂) adsorbent comprising alkali metal and/or alkaline earth metal; and a regeneration material that is responsive to inputted energy to generate heat in-situ to desorb adsorbed CO₂ from the adsorbent in the structured material assembly.

In a further aspect, a method of reducing the CO₂ content of a CO₂-containing gas mixture comprises contacting the CO₂-containing gas mixture with the CO₂ sorbent in the structured material assembly, to adsorb CO₂ on the CO₂ sorbent to produce a CO₂-reduced gas effluent that is recovered from the contacting, and when the CO₂ adsorbent has become loaded with adsorbed CO₂ to a predetermined extent, terminating the contacting, and regenerating the CO₂ adsorbent by applying energy to the regeneration material to cause it to responsively generate the in-situ heat to desorb previously adsorbed CO₂ from the CO₂ adsorbent to produce an essentially CO₂-containing effluent gas.

In a further aspect, a structured material assembly comprises Na₂CO₃ arranged on desorption material on a monolith substrate, constructed and arranged for (i) direct air contacting of the Na₂CO₃ to remove CO₂ from the air, and (ii) heating of the assembly so that the desorption material transmits heat to the Na₂CO₃ to desorb previously adsorbed CO₂ from the Na₂CO₃. In a related aspect, a process of using such structured material assembly is provided, wherein the process includes the steps of (1) adsorption, in which air is contacted with the structured material assembly and CO₂ is captured, (2) purge, wherein the structured material assembly is purged of non-adsorbed air components, and (3) desorption/regeneration, wherein electricity or other energy is supplied to heat the regeneration material so that it transmits heat to the Na₂CO₃, with CO₂ being desorbed and recovered from the structured material assembly.

The aspects, features, and advantages of the present disclosure will be further appreciated with reference to the following non-limiting Examples, as illustrative of specific embodiments and implementations of the disclosure.

### Example 1

A structured material assembly comprising a monolithic substrate onto which a sorbent support, a desorption material and a sorbent were coated, sequentially, was prepared, and used for CO₂ capture and regeneration. A 400 cells per square inch (cells/in²) electrically insulating cordierite monolith with approximate cylindrical dimensions of 3 inches long×0.7 inches diameter was prepared. The monolith was coated with 0.97 g of high-surface area (150 m²/g) alumina using a slurry followed by 0.60 g of a carbon-based conductive (55 ohm/sq at 50-micron film thickness) paint (Electric Paint, Bare Conductive). Finally, 1.95 g of Na₂CO₃ was coated onto the substrate. The conductive layer's purpose was to provide conductivity/resistance appropriate for Joule heating. Highly conductive silver paint (0.02-0.05 ohms/sq/mil) was applied to the end faces of the monolith to equalize the potential across any two points on opposing faces. The mass of the fully coated and prepared sample was 12.2 g. The resistivity of the exemplary structured material assembly was tested using point-probes and a multimeter (MM400 Digital Multimeter) prior to use, and its initial resistance was about 1100Ω as measured with the point probes contacted to equivalent positions on opposing faces.

The sample exemplary structured material assembly was loaded into an airtight reactor through which either nitrogen or certified (393 ppm CO₂) air obtained in a gas cylinder from Airgas or a combination thereof could be flowed in the range 20-1000 mL/min. Gas flow was controlled by calibrated mass flow controllers by Alicat Scientific. Certified air from the gas cylinder was passed through a water impinger until saturation at room temperature such that the saturated air had a water concentration of approximately 2.4 mol %. Gas analyzers were used to detect the CO₂ levels in the reactor effluent stream to measure the amount of adsorbed and desorbed CO₂. Electrodes were connected to each face of the monolith and electrical power was supplied using a 1.5 kW Magna-Power DC supply during the desorption step.

The sample was subjected to repeated adsorption/desorption cycling. In the adsorption step or cycle, humidified air was passed through the monolith at 1000 mL/min for 1 to 2 hours. The air flow rate of 1000 mL/min equates to a weight hourly space velocity (WHSV) of 26.6 hr⁻¹ with respect to the weight of the sorbent material and support material. At the end of the adsorption cycle of 1 to 2 hours, the concentration of CO₂ measured for the effluent air was approximately 350 ppm, indicating that the sorbent was approaching CO₂ working capacity. During desorption, nitrogen was flowed at 500 mL/min as the sample was resistively heated to about 120° C. using the conductive carbon paint with suitable electrical connections through the electrodes on the structured material assembly front and back face and the DC power supply.

As shown in FIG. 11, CO₂ desorption began at temperatures as low as 30° C. and increased in effectiveness at higher temperatures. A temperature range of about 70° C. to about 120° C. was an effective temperature range for desorbing CO₂ from the SMA. As a person having ordinary skill in the art will understand, various operational factors such as, for example, energy availability and use, cycle timing, materials, and many others are considered when determining a temperature for use during the desorption cycle. The exemplary SMA advantageously is effective at desorbing CO₂ across a range of temperatures thereby allowing for maximum flexibility and tunability for multiple locations and applications. For the sample, the temperature was measured with a Type-K thermocouple which was attached to the surface of the monolith along one side with electrically insulating, thermally conductive tape. After desorption, the fully coated sample mass was 12.2 g. During heating approximately 87 W of power input was provided to the sample (348 V and 0.25 A), and the sample was heated above 120° C. in under 2 minutes.

The results of the testing for Example 1 are shown in FIGS. 11-15 for the fourth cycle. FIGS. 11-15 relate to the desorption cycle. Over a temperature range of about 50° C. to about 120° C., the structured material assembly cumulatively desorbed between about 275-300 micromoles of CO₂. Moreover, significant desorption took place in 2 minutes. The testing showed that integrated resistive heating is an effective method for CO₂ desorption for the SMA.

### Example 2

A structured material assembly was prepared and used for CO₂ capture and regeneration. A 230 cells per square inch (cells/in²), 10 mil (0.254 mm) wall thickness resistive carbon-ceramic composite monolith (30% carbon, balance ceramic) with approximate cylindrical dimensions of 1.4 inches length×0.7 inches diameter was prepared through extrusion. Highly conductive (0.02-0.05 ohms/sq/mil) silver paint was applied to the end faces of the monolith to equalize the potential across any two points on opposing faces. Prior to painting or coating, the sample mass was 2.93 g. After painting, the sample was dried at 120° C. for 2 hr and weighed 3.04 g. The sample was then impregnated with 0.84 g of sorbent material. The sorbent material used for this exemplary embodiment was a promoted sodium carbonate. Resistance between the two faces after impregnation of sorbent material was approximately 16Ω.

The sample was loaded into a gastight reactor through which selected gas of nitrogen, or certified (393 ppm CO₂) air could be flowed in the range of 20-1000 mL/min. Gas flow was controlled by certified mass flow controllers by Alicat Scientific. Certified air was passed through a water impinger until saturation such that the saturated air had a water concentration of approximately 2.4 mol %. Gas analyzers were used to detect the CO₂ levels in the outlet stream to measure the amount of CO₂ that was adsorbed and desorbed.

Electrodes were contacted to front and back end faces of the SMA and power was supplied to the electrodes via a 1.5 kW Magna-Power DC power supply. The SMA was subjected to repeated cycling of adsorption and desorption phases. In the adsorption phase, 1000 ml/min of certified humidified air was passed through flow channels of the SMA for two hours such that CO₂ was adsorbed by the sorbent. The air flow rate of 1000 mL/min equates to a weight hourly space velocity (WHSV) of 92.4 hr⁻¹ with respect to the weight of the sorbent material. At the end of the two-hour period referred to as the adsorption phase, the CO₂ concentration of the air at the outlet of the SMA was measured at approximately 350 ppm, indicating that the SMA sorbent was near adsorption capacity. During desorption, nitrogen was flowed through the SMA at 1000 mL/min as the SMA was resistively heated to about 120° C. through heating of the carbon integrated throughout the substrate monolith via electrical circuit connection through the electrodes contacted to the front and back end faces of the structured material assembly and DC power supply to the electrodes.

Temperature was measured with a fiber optic interrogator system (ODiSI 6000 Series, Luna Inc.) capable of measuring temperature along its entire length with high spatial resolution. A fiber optic cable (<0.2 mm diameter) was woven through the flow channels of the SMA to measure temperature while allowing gas flow through the channels (>1 mm diameter). Temperatures were recorded and averaged across five channels and one surface. After the desorption phase, the fully coated sample mass was 3.88 g. During heating for desorption approximately 8.4 W of power was input to the SMA (12 V and 0.7 A), and the SMA was heated above 100° C. in under 5 minutes.

The results of this testing are shown in FIGS. 16-23 for four cycles of adsorption and desorption. The SMA demonstrated good adsorption and cycle stability (FIG. 18). Integrated resistive heating was shown to be an effective method for causing desorption for the exemplary SMA.

### Example 3

A monolithic substrate coated with desorption material was prepared and heating analysis performed. A 5.9 inch×5.9 inch×4 inch cordierite monolith with 400 cells per square inch was coated with 17.5 g of a carbon-based conductive (55 ohm/sq at 50 micron film thickness) paint (Electric Paint, Bare Conductive). The monolith substrate mass prior to coating was 624 g. Highly conductive (0.02-0.05 ohms/sq/mil) silver paint was applied to the end faces of the monolith substrate to equalize the potential across any two points on opposing faces. This paint was also used to adhere strips of 10 mil thick copper to each face. The resistance measured between the two faces was 890Ω.

Crocodile clips were used to connect a 1.5 kW Magna-Power DC supply to the monolith substrate using the copper strips. Four separate thermocouples were adhered to different points on the outer wall surfaces of the substrate to monitor temperature. Fiber glass insulation was placed around the walls of the substrate to minimize heat loss. The power supply was then used to resistively heat the substrate as temperatures throughout the substrate were monitored. Initially, 280 W was supplied to the substrate (500V and 0.56A). FIG. 26 is a line chart showing temperature as a function of time in seconds for the exemplary substrate as it was being heated. FIG. 26 shows that the substrate as a whole was heated to over 100° C. in less than three minutes.

The analysis in Examples 1 and 2 showed that heating a substrate in an SMA to over 60° C. was effective in desorbing CO₂ from the sorbent of the SMA. Example 3 shows that an exemplary embodiment of an SMA as described herein can be heated to over 100° C. in less than 3 minutes. Thus, advantageously, embodiments of the SMA described herein can efficiently and effectively desorb CO₂ in a timely manner with relatively low energy input.

### Example 4

A monolithic substrate coated with desorption material and having flow through electrodes painted on a front face and a back face was prepared and analyzed. The purpose of flow-through electrodes is to distribute current evenly across each face of the monolith substrate without obstructing air flow. A highly conductive silver paint can serve this purpose. Other suitable conductive materials can be used to provide flow through electrodes.

A 5.9 inch×5.9 inch×4 inch cordierite monolith substrate with 400 cells per square inch was coated with 21.9 g of a carbon-based conductive (55 ohm/sq at 50 micron film thickness) paint (Electric Paint, Bare Conductive). The resistance was measured across different parts of the faces using a multimeter and point probes.

Silver paint having a sheet resistance ranging from 0.02-0.05 ohms/sq/mil was then applied to the end faces of the monolith to equalize the potential across any two points on opposing faces. The point probes were then used to measure the resistance in the same positions. FIG. 27A illustrates resistance prior to painting and FIG. 27B illustrates resistance after painting. As can be seen in FIGS. 27A and 27B, the resistance dropped drastically after painting and crucially was the same at all points across the opposing faces regardless of where on the faces the point probes were positioned.

### Example 5—Evaluation of Heating Profile and Resistivity for a Monolith Substrate

A large (6.34 in.×6.34 in.×5.88 in.) high porosity cordierite full-size monolith with 400 cells per square inch and 7 mm walls was provided for testing. The monolith was cut, perpendicular to channel direction, approximately in half. The cut monolith face was sanded to create a smooth surface for coating, after which the dimension along the channels was 2.8 inches. The monolith was dried overnight at 120° C. in air. The dried monolith had a mass of 422.73 g. The monolith was dip coated with a phenolic resin solution that was 25 wt % phenolic resin and 75 wt % deionized water. Excess resin solution was removed from the coated monolith with high velocity air. The resin-coated monolith was cured in air at 120° C. to thermoset. The post-curing mass was 478 g, giving a resin loading of 0.49 g/in³. Three cylindrical cores (diameter=0.75 in) and one corner section (0.66 in square) were removed from the cured monolith for characterization.

Pyrolysis was performed on the parent monolith (large piece without the cores) under vacuum conditions (1E-2 Torr) in a vacuum furnace. More specifically, the parent monolith sample was heated to 850° C. at a rate of 2° C./min and held for four hours before slowly (<2° C./min) cooling back to ambient temperature.

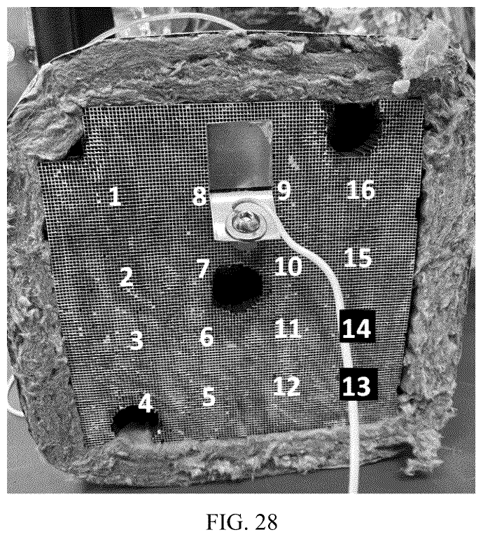

The pyrolyzed monolith was prepared for Joule heating testing. The outer skin of the monolith was removed (cut off) to remove excess carbon content in the skin, which gives higher electrical conductivity than the monolith channel walls. The faces of the pyrolyzed monolith were painted with a highly conductive silver paint (0.02-0.05 Ω/sq/mil). A copper tab having dimensions of 2 in.×1 in. was cut into 1 in. square sections. One of the 1 in. square sections of the copper tab was adhered to one of the faces of the monolith with a high temperature adhesive and clamped in place to set overnight under ambient conditions. The other 1 in. square section of the copper tab was used to connect the wire from a power supply unit. Mineral wool thermal insulation was wrapped around the 4 walls. The preparation arrangement is shown in FIG. 28, which is a photograph of the pyrolyzed monolith prepared for heat testing. Resistance between the two copper terminals was measured as about 4.5Ω. The insulated monolith was loaded into a bench reactor, which remained unsealed.

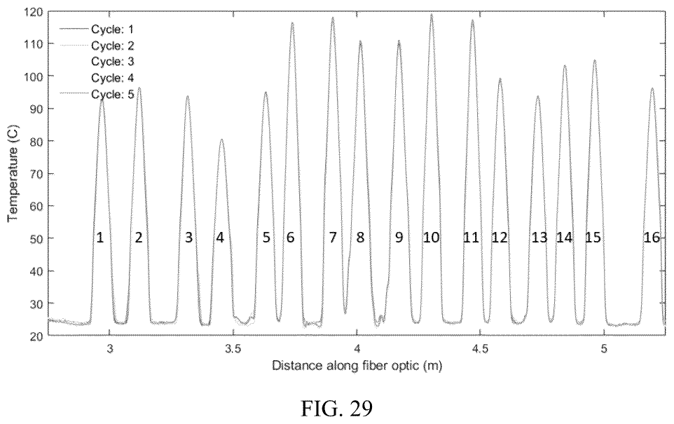

An Optical Distributed Sensor Interrogator (ODiSI) measurement system was used to probe the temperature distribution along numbered channels (5.2 mm spatial resolution) as a function of time. The ODiSI instrument used Rayleigh backscattering to acquire both strain and temperature data. FIG. 29 is a chart showing temperature as a function of distance in meters along the fiber optic temperature probe for probes 1-16. In FIG. 28, the numbers (1-16) indicate positions/channels in the monolith where fiber optic sensors were threaded for heat testing. The spacing between the measured channels was 30 mm. The numbers correspond to peaks shown in the chart of FIG. 29.

A 1.5 kW power supply was used for heating. A constant power of ˜64 W was applied during heating until the temperature of the channel with the lowest temperature reached a peak temperature of at least 80° C. Shortly thereafter the power was turned off. Throughout the measurement, fiber optic data (temperature profile along fiber optic) and power supply data (voltage, current and power) were recorded as a function of time.

The temperature profile along the fiber optic sensors was measured and is shown for 5 cycles in FIG. 29. FIG. 29 shows temperature versus distance along the fiber optic sensor. The temperature snapshot of the fiber optic sensors shown in FIG. 29 was taken 5 seconds after the temperature of the lowest temperature channel reached 80° C. The temperature profiles for all channels for all cycles 1-5 largely overlay one another demonstrating great reproducibility of heating and the absence of drastic initial degradation. Moreover, the temperatures of all 16 channels lie within the 80-120° C. temperature range desired for desorption.

The time to heat from ambient to above 80° C. for the lowest temperature channel (channel 4) is shown in Table 1 below for the different cycles. All cycles had remarkably similar heating times except for cycle 1. The first cycle heats slightly faster due to a high initial starting temperature, which reflects changing ambient conditions.

TABLE 1

| Cycle | Starting T Channel 4 (° C.) | Time to heat to 80° C. (s) |
|---|---|---|
| 1 | 21.8 | 434 |
| 2 | 19.5 | 451 |
| 3 | 18.5 | 451 |
| 4 | 18.0 | 456 |
| 5 | 18.5 | 454 |

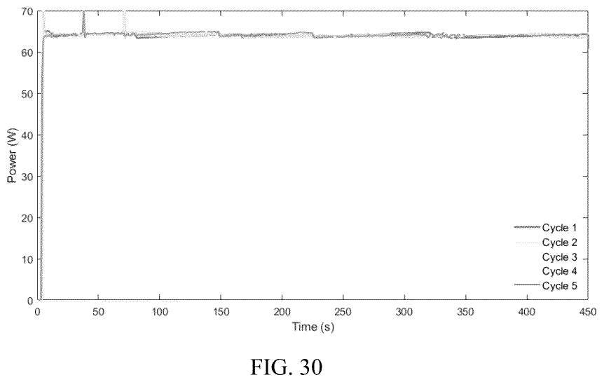

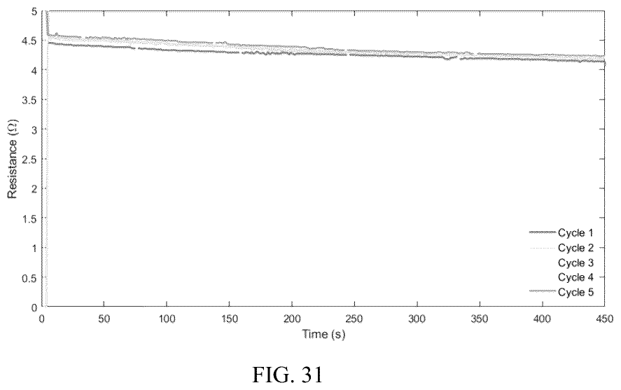

FIG. 30 is a graph showing the power input to the monolith over five heating cycles. FIG. 30 shows that a constant power of 64 W was supplied throughout the duration of heating for all five cycles. FIG. 31 is a graph showing monolith resistance overtime for the five heating cycles. FIG. 31 shows that resistances decreased over time for all cycles, which demonstrates a negative temperature coefficient (NTC) behavior, which is typical of semiconductors. NTC behavior occurs when a physical property (such as thermal conductivity or electrical resistivity) of a material lowers with increasing temperature.

### Example 6. Resin as Desorption Material Coating on Monolith Substrate in Combination with Sorbent and Alumina Support

A high porosity cordierite monolith with 400 cells per square inch and 7 mm walls with approximate dimensions of 6 in.×6 in.×6 in. was provided. The monolith was cut approximately in half perpendicular to the channels. One half of the cut monolith was wash-coated with an aqueous phenolic resin solution (75 wt % deionized water and 25 wt % phenolic resin) and cured overnight at 120° C. in air.

Two small cylindrical cores (approximately 1.5 in. length and 0.75 in. diameter) were drilled from the cured monolith and used as substrates upon which the support material (alumina) and sorbent were impregnated.

Alumina support material was loaded onto one of the cores as described above (i.e., first core). The first core was pyrolyzed in a tube furnace at 850° C. for 4 hours under an inert oxygen-free atmosphere. An aqueous solution with an active component comprising Na-Lysinate and Na₂CO₃ was coated onto the first core and the fully integrated core was dried in an oven at 80° C. overnight.

A second core, which had also been resin-coated and cured, was pyrolyzed in a tube furnace at 850° C. for 4 hours under an inert oxygen-free atmosphere. An alumina support was loaded onto the second core after pyrolysis of the second core. The pyrolyzed and alumina-loaded core was calcined at 900° C. in nitrogen for 4 hours. An aqueous solution with active component of 80 wt % Na-Lysinate and 20 wt % Na₂CO₃ was loaded (1.74 g/inch³) onto the core and the active-loaded core was dried in an oven at 80° C. overnight.

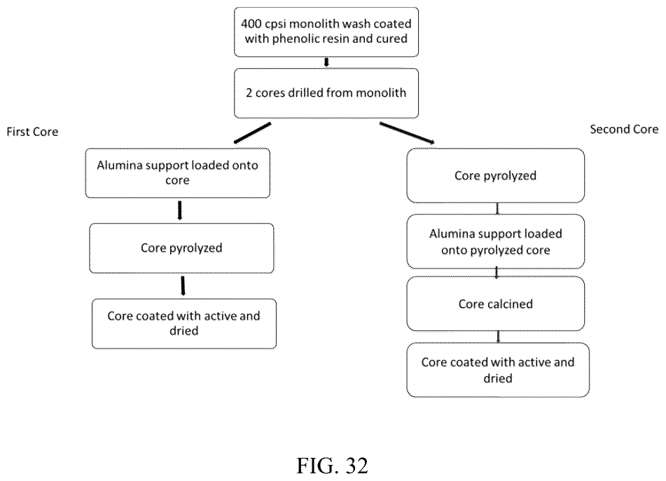

A schematic flow chart showing the processing steps for the first core and the second core is provided as FIG. 32.

### Example 7—Using Phenolic Resin as Desorption Material

A process for coating a sorbent onto a full-sized commercial cordierite monolith with integrated resistive heating is described. A large (6.34″×6.34″×5.88″) high porosity cordierite full-size monolith with 400 CPSI and 7 mil walls was used. The monolith was cut, perpendicular to channel direction, approximately in half. The dimensions of the monolith were 6.34″ in length, 6.34″ in width, and 2.75″ in depth. The monolith was impregnated with phenolic resin via dip-coating with a solution that was 16.7 wt % phenolic resin and 73.3 wt % deionized water. Excess solution was removed after coating via air knifing, and the coated monolith was then cured at 150° C. to thermoset.

The cured components were then pyrolyzed in a high temperature furnace (SentroTech STV −1600° C.) under vacuum (1×10⁻² Torr) conditions at 850° C. for four hours. The pyrolyzed carbon loading was 0.14 g/in³. The pyrolyzed conductive monolith was then coated with alumina (SASOL TH100/150 L4) and sorbent. The alumina was applied to the monolith in the form of a slurry. After being coated with alumina, the coated monolith was dried in air in an oven at 120° C. overnight. The dried, coated monolith then underwent the same inert temperature treatment as the resin for pyrolysis. The sorbent, which comprised sodium lysinate/sodium carbonate, was coated onto the alumina coated monolith, by wash-coating with an aqueous solution of the sorbent. The excess sorbent solution in monolith channels was removed by forced air using an air knife. Subsequently, the sorbent coated monolith was dried at 80° C. in air in an oven overnight. The amounts of alumina and sorbent coated onto and inside the channels of the large monolith tested were 1.30 g/in³, and 0.99 g/in³, respectively.

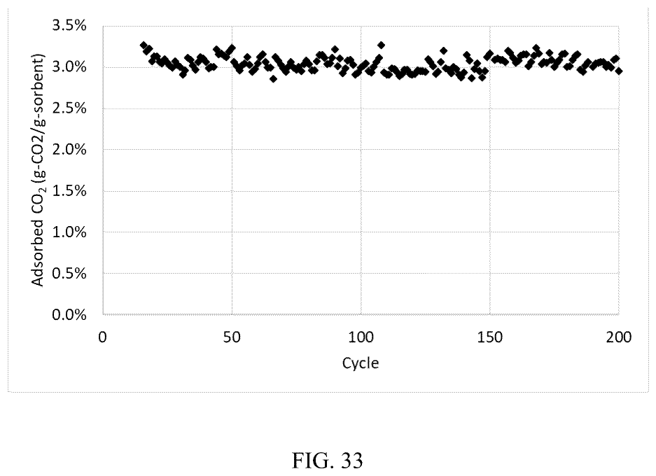

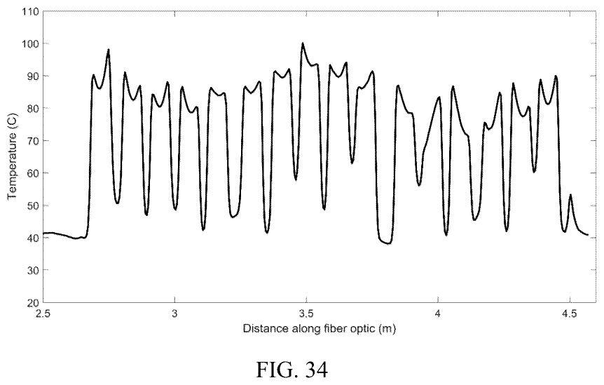

The conductive monolith was prepared for resistive heating by adding highly conductive silver paint and copper electrodes to opposing exterior walls to act as flow through electrodes. The fiber optic temperature sensors using the Luna ODiSI interrogator system (Rayleigh backscattering principle) were woven through 16 channels to directly measure the internal channel temperature along the channel walls. Electricity was supplied via wires attached to the copper electrodes from a DC power supply, and the sample was resistively heated via automated power control while monitoring internal temperatures. After being loaded into the bench-scale reactor and connected to the 8 kW power supply, the sample was cycled between adsorbing CO₂, by flowing humidified air through the sample, and desorbing CO₂ by heating the monolith electrically using the power supply under a moderate vacuum (−8.5 PSI) with a dry nitrogen sweep gas flowing at 4 SLPM. The same reactor set-up was used as in example 5 with some minor modifications. Two hundred cycles of adsorption and desorption (via direct Joule heating) were performed on the monolith. The average amount of CO₂ adsorbed for cycles 16-200 was 3.32%±0.09 g. The uncertainty represents one standard deviation. FIG. 33 is a chart showing adsorption capacity per cycle. FIG. 33 demonstrates good stability in terms of CO₂ capture for the integrated SMA up to 200 cycles. FIG. 34 is a chart showing temperature at a single exemplary point in time along the fiber optic during the desorption phase. The 16 large peaks represent channels and demonstrate good temperature uniformity.

While the disclosure has been set forth herein in reference to specific aspects, features and illustrative embodiments, it will be appreciated that the utility of the disclosure is not thus limited, but rather extends to and encompasses numerous other variations, modifications, and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications, and alternative embodiments, within its spirit and scope.

What is claimed is:

1. A method for forming an integrated composite, comprising
providing a three-dimensional substrate having at least one channel;
coating the substrate with a phenolic resin, wherein coating comprises dispersing the phenolic resin on the substrate, impregnating the phenolic resin in the substrate or a combination of both;
curing the substrate and the phenolic resin;
heating the cured substrate and cured phenolic resin to a temperature in a range of about 600° C. to about 1100° C. in an inert environment thereby pyrolyzing the phenolic resin, forming a conductive carbon network on, in, or both on and in the substrate; and
coating a support material on, in, or both on and in the substrate to form an integrated composite.

2. The method of claim 1, further comprising coating a sorbent on or in the integrated composite.

3. The method of claim 2, wherein the sorbent comprises one or more CO₂ sorbents.

4. The method of claim 2, wherein the sorbent comprises a solid inorganic base.

5. The method of claim 4, wherein the solid inorganic base comprises a Ca-based, Mg-based, K-based, and Na-based oxide, hydroxide, and/or carbonate.

6. The method of claim 2, wherein the sorbent comprises one or more of amino acid, amino acid salt, sodium oxide, sodium carbonate, calcium oxide, calcium carbonate, potassium carbonate, magnesium oxide, magnesium hydroxide, magnesium carbonate, barium oxide, or barium carbonate.

7. The method of claim 6, wherein the amino acid salt comprises one or more of sodium lysinate, potassium lysinate, lithium lysinate, potassium glycinate, sodium glycinate, lithium glycinate, histidine sodium salt, taurine sodium salt, aspartic acid sodium salt, asparagine sodium salt, alanine sodium salt, leucine sodium salt, or taurine potassium salt.

8. The method of claim 1, wherein curing comprises heating the substrate coated with phenolic resin to a temperature of about 100° C. to 150° C. to cure it prior to pyrolyzing it.

9. The method of claim 1, wherein the three-dimensional substrate comprises a monolithic, laminate, or wire mesh form.

10. The method of claim 1, wherein the substrate comprises cordierite, alumina, silica/alumina, silicon carbide (SiC), titania, silica, magnesia, zirconia, metal mesh, carbon, and combinations thereof.

11. The method of claim 1, wherein the phenolic resin coated on the substrate comprises a solution of phenolic resin and a catalyst.

12. The method of claim 1, wherein the phenolic resin coated on the substrate comprises a solution of phenolic resin and deionized water having a mass ratio of deionized water:
phenolic resin.

13. The method of claim 12, wherein the ratio of deionized water:phenolic resin ranges from 1:5 to 100:1.

14. The method of claim 1, wherein coating the support on the substrate comprises washcoating the substrate with a slurry of support material.

15. The method of claim 1, wherein the support material comprises alumina, silica, titania, zirconia, or combinations thereof.

16. The method of claim 1, wherein the support is coated on or in the substrate after the phenolic resin is dispersed on or in the substrate and cured but before it is pyrolyzed.

17. The method of claim 1, wherein the support is coated on or in the substrate after the phenolic resin is dispersed on or in the substrate and the substrate and phenolic resin are cured and pyrolyzed.

18. The method of claim 1, further comprising heating the support-coated substrate to a temperature of about 300° C. to about 1000° C. in inert environment to calcine it.

19. A structured material assembly for removing CO₂ from a gas, comprising
a three-dimensional substrate,
a conductive carbon network coated on the three-dimensional substrate, and
a sorbent for adsorbing CO₂ from the gas.

20. The SMA of claim 19, wherein the conductive carbon network is responsive to inputted energy to generate heat to desorb CO₂ from the sorbent.
